(19) United States
(12) Patent Application Publication
(10) Pub. No.: US 2026/0347246 A1
(43) Pub. Date: Nov. 5, 2026

(54) METHODS OF CHEMICALLY STRENGTHENING GLASS, GLASS-BASED ARTICLES, AND CONSUMER ELECTRONIC DEVICES

(71) Applicant: CORNING INCORPORATED, CORNING, NY (US)

(72) Inventors: YUHUI JIN, PAINTED POST, NY (US); WILLIAM JAMES MCKENDRICK, PAINTED POST, NY (US); BALAMURUGAN MEENAKSHI SUNDARAM, PAINTED POST, NY (US); SHELBY KERIN PEARL, LOCUST, NC (US); LJERKA UKRAINCZYK, ITHACA, NY (US); STEPHEN WALKER, CORNING, NY (US)

(21) Appl. No.: 19/666,801

(22) Filed: May 4, 2026

Related U.S. Application Data
(60) Provisional application No. 63/799,857, filed on May 5, 2025.

(51) Int. Cl. C03C 21/00; C03C 3/21; G06F 1/16

(52) U.S. Cl. CPC C03C 21/002; C03C 3/21; G06F 1/1656

(57) ABSTRACT

Methods of chemically strengthening a glass-based substrate includes contacting a first major surface of the glass-based substrate with a molten salt solution maintained at a first temperature from 330 °C to 530 °C for from 10 minutes to 8 hours to form a compressive stress region extending from the first major surface to a first depth of compression. Methods further include adding a phosphate salt to the molten salt solution during the contacting.

This application claims the benefit of priority under 35 U.S.C. § 119 of U.S. Provisional Application Ser. No. 63/799,857 filed on May 5, 2025, the content of which is relied upon and incorporated herein by reference in its entirety.

### FIELD

The present disclosure relates generally to methods of chemically strengthening glass, glass-based articles, and consumer electronic devices, more particularly, to methods of chemically strengthening glass using a molten salt solution and glass-based articles, and consumer electronic devices produced by such methods.

### BACKGROUND

Glass articles are commonly used, for example, in display devices, e.g., liquid crystal displays (LCDs), electrophoretic displays (EPD), organic light-emitting diode displays (OLEDs), plasma display panels (PDPs), or the like.

It is known to use glass-based materials as part of consumer electronic devices including displays. Also, it is known to chemically strengthen glass-based materials by ion exchange with nitrate salts. However, there is a need to develop new methods of forming chemically strengthened glass-based articles.

### SUMMARY

There are set forth herein methods of chemically strengthening glass by adding a phosphate salt to the molten salt solution during the chemical strengthening process and glass-based articles produced using the same. Adding a phosphate salt (e.g., less than or equal to 2.0 wt %, from 0.05 wt % to 0.5 wt %) to the molten salt solution during the chemical strengthening process can increase the properties of the resulting glass-based article without leaving residues, without impairing the optical properties, and/or without impairing the cosmetic appearance of the resulting glass-based article. Also, adding the phosphate salt can enable elevated compressive stress, including at depths greater than those typically achieved from a potassium spike in a multi-step ion-exchange process, to be achieved. In particular, the high lithium glasses discussed herein can release a significant amount of lithium into the molten salt solution that could otherwise impair the compressive stress achieved—especially near the surface of the glass-based substrate.

Without wishing to be bound by theory, it is believed that the phosphate salt can preferentially bind to lithium cations in the molten salt solution (e.g., that can be present due to the current and/or previous chemical strengthening treatments using the molten salt solution), which can improve the stress profile and/or mechanical properties of the resulting glass-based article. For example, when the phosphate salt is trisodium phosphate (Na₃PO₄, TSP) can react with lithium in the molten salt solution to form lithium disodium phosphate (LiNa₂PO₄) that can precipitate out of the molten salt solution, reducing the concentration of lithium in solution in the molten salt solution. Consequently, removing (or at least decreasing an activity) of lithium in the molten salt solution can increase the effect of the chemical strengthening treatment on the resulting stress profile and/or mechanical properties since the competition between lithium and larger alkali metals is reduced. As demonstrated by the Examples herein (see Table 1 and FIG. 10), adding the phosphate salt can increase a maximum compressive stress (e.g., at the first major surface) and/or compressive stress at a predetermined depth (e.g., 20 μm, 40 μm) from the first major surface. Also, as demonstrated by the Examples herein (see FIG. 11), the addition of the phosphate salt can increase a retained strength (i.e., failure strength) of the resulting glass-based article for flaws having an intermediate depth (e.g., from 20 μm to 60 μm). Additionally, as shown in FIG. 14, the addition of the phosphate salt can reduce an extent of flaws (i.e., effective flaw depth) formed in the Slapper Test.

Without wishing to be bound by theory, it is believed that the phosphate salt can take a significant amount of time (e.g., greater than or equal to an hour, from greater than or equal to 2 hours to less than or equal to 4 hours) to achieve the full extent of the lithium concentration reduction. Consequently, adding the phosphate salt partway (e.g., at least 45 minutes after the start of the chemical strengthening process with that molten salt solution, at least 45 minutes before the end of the chemical strengthening process with that molten salt solution, from 25% to 75% of the way through the chemical strengthening process with that molten salt solution), can act to reduce (e.g., limit, reduce) the lithium concentration in the molten salt solution throughout a significant portion of the remainder of the chemical strengthening process (if not the entire remainder of the chemical strengthening process). As a result, the composition of the molten salt bath can shift from before the phosphate salt is added versus after the phosphate salt is added. In some situations, this shift in composition (through the removal and/or decreased activity of lithium) can have an effect similar to a multi-step chemical strengthening process even though a single molten salt solution is used. Additionally or alternatively, the addition of the phosphate salt can limit a maximum concentration of lithium in the molten salt solution during the chemical strengthening process. Consequently, higher compressive stress and/or stress profiles can be achieved as the effect of reverse ion-exchange from the lithium concentration in the molten salt solution is reduced. In particular, when the composition of the glass-based substrate being chemically strengthened contains a larger amount of lithium (e.g., from greater than or equal to 20 mol % to less than or equal to 45 mol %), an increase in lithium concentration in the molten salt solution can be significant (e.g., greater than or equal to 0.1 wt %) during the chemical strengthening process. Adding the phosphate salt in this situation, can mitigate the extent of this increase in lithium. Additionally, adding the phosphate salt during the chemical strengthening treatment can increase a throughput and/or a longevity of the molten salt solution. As discussed above, the phosphate salt can take a significant amount of time to have full effect; so, adding the phosphate salt during the chemical strengthening process can reduce an amount of time after the end of the chemical strengthening process before the phosphate salt has full effect, which allows for a subsequent chemical strengthening processing using the molten salt solution to begin sooner than if the phosphate salt was added after the chemical strengthening process was complete.

The addition of the phosphate salt during the chemical strengthening of the glass-based substrate (to form the glass-based article) can reduce the extent that a lithium concentration increases during the remainder of the chemical strengthening process (e.g., after the phosphate salt is added). Additionally or alternatively, the addition of the phosphate salt during the chemical strengthening of the glass-based substrate (to form the glass-based article) can reduce the extent that a lithium concentration increases by the time that the phosphate salt takes full effect (e.g., 4 hours after the end of the chemical strengthening process). Additionally or alternatively, the addition of the phosphate salt can achieve a lithium concentration in the molten salt solution (based on 100 wt % of the molten salt solution)—at the end of the chemical strengthening process and/or 4 hours after the end of the chemical strengthening process with the corresponding molten salt solution-below a predetermined threshold (e.g., less than or equal to 0.30 wt %, from greater than or equal to 0.10 wt % to less than or equal to 0.30 wt %). Further, due to the high lithium content glass-based substrates being chemically strengthened, the phosphate released from the phosphate salt can bind with lithium already released into the molten salt solution rather than aggregating at the surface of glass-based substrate where it could cause cosmetic defects (e.g., “spotting”). Indeed, adding the phosphate salt partway through the chemical strengthening can ensure that there is sufficient lithium in the molten salt solution for this binding to occur.

The following presents a simplified summary of the disclosure to provide a basic understanding of some aspects and embodiments described in the detailed description.

Aspect 1. A method of chemically strengthening a glass-based substrate comprising:
contacting at least a first major surface of the glass-based substrate with a molten salt solution maintained at a first temperature from greater than or equal to 330 °C to less than or equal to 530 °C for a first period of time from greater than or equal to 10 minutes to less than or equal to 8 hours to form a compressive stress region extending from the first major surface to a depth of compression; and
adding a phosphate salt to the molten salt solution during the contacting.

Aspect 2. The method of aspect 1, wherein the phosphate salt comprises trisodium phosphate (Na₃PO₄), tripotassium phosphate (K₃PO₄), disodium phosphate (Na₂HPO₄), dipotassium phosphate (K₂HPO₄), sodium tripolyphosphate (Na₅P₃O₁₀), potassium tripolyphosphate (Na₅P₃O₁₀), sodium pyrophosphate (Na₄P₂O₇), potassium pyrophosphate (K₄P₂O₇), trisodium pyrophosphate (Na₃HP₂O₇), tripotassium pyrophosphate (K₃HP₂O₇), disodium pyrophosphate (Na₂H₂ P₂O₇), dipotassium pyrophosphate (K₂H₂P₂O₇), or combinations thereof.

Aspect 3. The method of any one of aspects 1-2, wherein an amount of the phosphate salt added to the molten salt solution, based on 100 wt % of the molten salt solution before adding the phosphate salt, is from greater than or equal to 0.05 wt % to less than or equal to 2.0 wt %.

Aspect 4. The method of aspect 3, wherein the amount of the phosphate salt added to the molten salt solution is from greater than or equal to 0.10% wt % to less than or equal to 0.5 wt %.

Aspect 5. The method of any one of aspects 1-4, wherein the phosphate salt is added at a time after a start of the contacting, where the time is from 25% to 75% of the first period of time.

Aspect 6. The method of any one of aspects 1-4, wherein the first period of time is from greater than or equal to 2 hours to less than or equal to 6 hours, wherein the phosphate salt is added from 45 minutes to 105 minutes after a start of the contacting.

Aspect 7. The method of any one of aspects 1-4, wherein the first period of time is from greater than or equal to 2 hours to less than or equal to 6 hours, wherein the phosphate salt is added from 45 minutes to 105 minutes prior to an end the contacting.

Aspect 8. The method of any one of aspects 1-7, wherein the glass-based substrate is a lithium-containing aluminosilicate glass.

Aspect 9. The method of any one of aspects 1-8, wherein the glass-based substrate comprises, based on 100 mol % of the glass-based substrate:
from greater than or equal to 50 mol % to less than or equal to 75 mol % SiO₂;
from greater than or equal to 0.5 mol % to less than or equal to 5 mol % Al₂O₃;
from greater than or equal to 20 mol % to less than or equal to 45 mol % Li₂O;
from greater than or equal to 0.0 mol % to less than or equal to 2.0 mol % Na₂O;
from greater than or equal to 0.0 mol % to less than or equal to 1.0 mol % K₂O;
from greater than or equal to 0.0 mol % to less than or equal to 5.0 mol % RO, where RO is a total amount of MgO, CaO, SrO, and BaO;
from greater than or equal to 0.0 mol % to less than or equal to 6.0 mol % ZrO₂; and
from greater than or equal to 0.1 mol % to less than or equal to 3.0 mol % P₂O₅.

Aspect 10. The method of any one of aspects 8-9, wherein the glass-based substrate is free of B₂O₃.

Aspect 11. The method of any one of aspects 8-10, wherein the glass-based substrate comprises, based on 100 mol % of the glass-based substrate:
from greater than or equal to 20 mol % to less than or equal to 45 mol % Li₂O;
less than or equal to 0.5 mol % Na₂O; and
less than or equal to 0.3 mol % K₂O.

Aspect 12. The method of any one of aspects 8-11, wherein the glass-based substrate comprises, based on 100 mol % of the glass-based substrate:
from greater than or equal to 20 mol % to less than or equal to 45 mol % Li₂O;
from greater than or equal to 0.0 mol % to less than or equal to 2.0 mol % RO, where RO is a total amount of MgO, CaO, Sr, and BaO;
from greater than or equal to 1.0 mol % to less than or equal to 4.0 mol % ZrO₂; and
from greater than or equal to 0.2 mol % to less than or equal to 2.0 mol % P₂O₅.

Aspect 13. The method of any one of aspects 8-12, wherein a concentration of lithium in solution in the molten salt solution after an end of the contacting is, as a percentage of the concentration of lithium in solution in the molten salt solution before the contacting, from greater than or equal to 50% to less than or equal to 133%.

Aspect 14. The method of any one of aspects 8-12, wherein a concentration of lithium in solution in the molten salt solution 4 hours after an end of the contacting is, as a percentage of the concentration of lithium in solution in the molten salt solution before the contacting, from greater than or equal to 50% to less than or equal to 133%.

Aspect 15. The method of any one of aspects 8-12, wherein a concentration of lithium in solution in the molten salt solution decreases from an end of the contacting to 4 hours after the end of the contacting.

Aspect 16. The method of aspect 15, wherein the concentration of lithium in solution in the molten salt solution 4 hours after the end of the contacting, as a percentage of the concentration of lithium in solution in the molten salt solution at the end of the contacting, is from greater than or equal to 50% to less than or equal to 80%.

Aspect 17. The method of any one of aspects 8-12, wherein a concentration of lithium in solution in the molten salt solution decreased from before the contacting to after the contacting.

Aspect 18. The method of any one of aspects 8-12, wherein a concentration of lithium in solution in the molten salt solution decreased from before the contacting to 4 hours after an end of the contacting.

Aspect 19. The method of any one of aspects 8-12, wherein a concentration of lithium in solution in the molten salt solution 4 hours after an end of the contacting, based on 100 wt % of the molten salt solution 4 hours after the end of the contacting, is from greater than or equal to 0.10 wt % to less than or equal to 0.30 wt %.

Aspect 20. The method of any one of aspects 1-19, wherein the molten salt solution comprises, based on 100 wt % of the molten salt solution before the contacting:
from greater than or equal to 20 wt % to less than or equal to 100 wt % of a sodium salt; and
from greater than or equal to 0 wt % to less than or equal to 80 wt % of a potassium salt.

Aspect 21. The method of any one of aspects 1-20, wherein the depth of compression is greater than or equal to 100 micrometers.

Aspect 22. The method of any one of aspects 1-20, wherein a thickness of the substrate defined between the first major surface and a second major surface opposite the first major surface is from greater than or equal to 30 micrometers to less than or equal to 3 millimeters.

Aspect 23. The method of aspect 22, wherein the depth of compression divided by the thickness is from greater than or equal to 0.20 to less than or equal to 0.30.

Aspect 24. The method of any one of aspects 1-23, wherein a maximum compressive stress in the compressive stress region is greater than or equal to 350 MegaPascals, and a stress at a depth of 40 micrometers from the first major surface is greater than or equal to 200 MegaPascals after the contacting.

Aspect 25. The method of any one of aspects 1-24, wherein, after the contacting, the glass-based substrate exhibits a retained strength at a flaw depth of 40 micrometers is greater than or equal to 500 MegaPascals.

Aspect 26. The method of any one of aspects 1-25, wherein, after the contacting, the glass-based substrate exhibits a flaw depth from greater than or equal to 50 micrometers to less than or equal to 140 micrometers in a Slapper Test.

Aspect 27. A glass-based article produced by the method of any one of aspects 1-26.

Aspect 28. A consumer electronic device comprising: a housing comprising a front surface, a back surface, and side surfaces; electrical components at least partially within the housing, the electrical components comprising a controller, a memory, and a display, the display is at or adjacent to the front surface of the housing; and a cover substrate disposed over the display, wherein at least one of a portion of the housing or the cover substrate comprises a glass-based article produced by the method of any one of aspects 1-26.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### BRIEF DESCRIPTION OF THE DRAWINGS

These and other features, aspects, embodiments, and advantages are better understood when the following detailed description is read with reference to the accompanying drawings, in which:

FIG. 1 is a schematic plan view of an example consumer electronic device according to aspects of the disclosure;

FIG. 2 is a schematic perspective view of the example consumer electronic device of FIG. 1;

FIG. 3 is a schematic perspective view of a foldable consumer electronic product;

FIG. 4 is a flow chart illustrating example methods of chemically strengthening a glass-based article in accordance with aspects of the disclosure;

FIG. 5 schematically illustrates a step in a method of chemically strengthening a glass-based substrate comprising contacting the glass-based substrate with a molten salt solution;

FIG. 6 schematically illustrates a step in a method of chemically strengthening a glass-based substrate comprising adding a phosphate salt to the molten salt solution during the contacting the glass-based substrate with the molten salt solution;

FIG. 7 schematically illustrates a cross-section of a chemically strengthened glass-based article in accordance with aspects of the present disclosure;

FIG. 8 schematically illustrates a step in a method of chemically strengthening a glass-based substrate comprising further chemically strengthening the glass-based substrate with a molten salt solution;

FIG. 9 schematically illustrates a step in a method of chemically strengthening a glass-based substrate comprising adding a phosphate salt to the molten salt solution during the further chemically strengthening the glass-based substrate with the molten salt solution;

FIG. 10 illustrates stress profiles having compressive stress (σ) in MegaPascals (MPa) on the vertical axis (i.e., y-axis) as a function of depth (d) from the first major surface in millimeters (mm) on the horizontal axis (i.e., x-axis);

FIG. 11 illustrates a relationship between failure stress (of) in MegaPascals (MPa) on the vertical axis (i.e., y-axis) as a function of flaw depth (df) in micrometers (μm) on the horizontal axis (i.e., x-axis) using the Ring-on-Ring Test;

FIG. 12 illustrates a relationship between failure load (Lf) in kilograms-force (kgf) on the vertical axis (i.e., y-axis) as a function of flaw depth (df) in micrometers (μm) on the horizontal axis (i.e., x-axis) using the Ring-on-Ring Test;

FIG. 13 illustrates flaw depth (df) in micrometers (μm) on the vertical axis (i.e., y-axis) for Examples 5-6 and Comparative Example CC as measured in the Slapper Test using an 80 grit slapper;

FIG. 14 illustrates flaw depth (df) in micrometers (μm) on the vertical axis (i.e., y-axis) for Examples 5-6 and Comparative Examples CC-DD as measured in the Slapper Test using a 30 grit slapper;

FIG. 15 illustrates potassium oxide (K₂O) concentration profiles in mol % on the vertical axis (i.e., y-axis) as a function of depth (d) from the surface is micrometers (μm) on the horizontal axis (i.e. x-axis) as measured using electron microprobe analysis (EMPA) for Examples 5-6 and Comparative Example CC; and

FIG. 16 illustrates sodium oxide (Na₂O) concentration profiles in mol % on the vertical axis (i.e., y-axis) as a function of depth (d) from the surface is micrometers (μm) on the horizontal axis (i.e. x-axis) as measured using electron microprobe analysis (EMPA) for Examples 5-6 and Comparative Example CC.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, claims may encompass many different aspects of various aspects and should not be construed as limited to the aspects set forth herein.

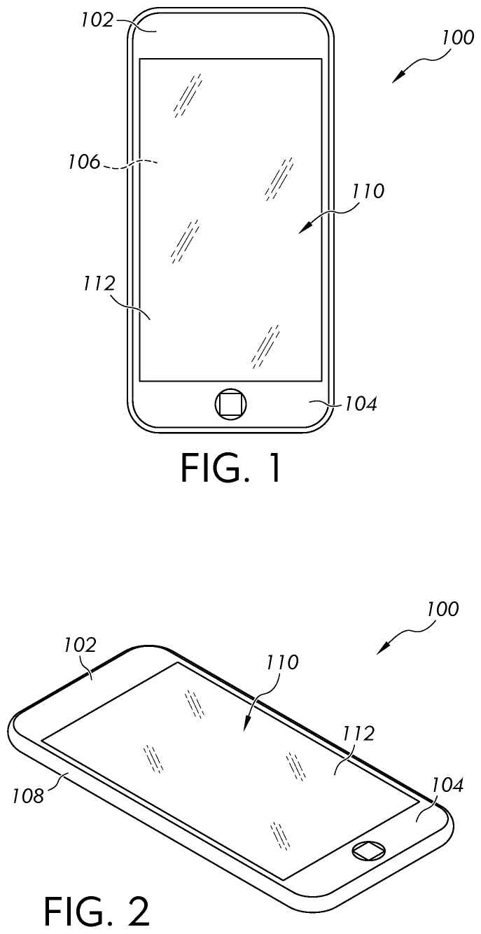

FIG. 7 schematically illustrates a glass-based article 701. FIGS. 1-3 illustrate schematic views of a consumer electronic device 100 and/or 301 that can include the glass-based article. Unless otherwise noted, a discussion of features of aspects of one glass-based article and/or methods of chemically strengthening a glass-based substrate to make the same can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

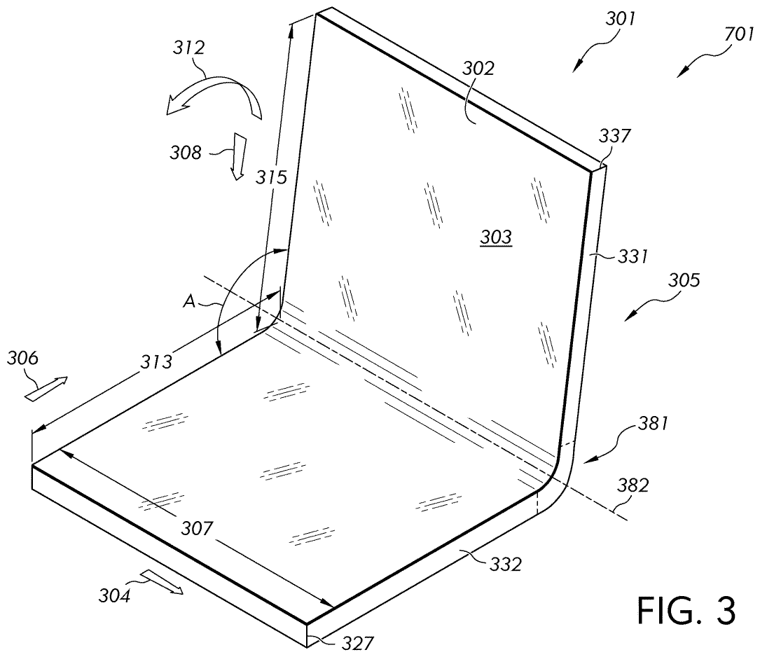

Aspects of the disclosure can comprise a consumer electronic device. The consumer electronic device can comprise a front surface, a back surface, and side surfaces. The consumer electronic device can further comprise electrical components at least partially within the housing. The electrical components can comprise a controller, a memory, and a display. The display can be at or adjacent to the front surface of the housing. The display can comprise a liquid crystal display (LCD), an electrophoretic display (EPD), an organic light-emitting diode (OLED) display, or a plasma display panel (PDP). The consumer electronic device can comprise a cover substrate disposed over the display. In aspects, at least one of a portion of the housing or the cover substrate comprises the glass-based article 701 (see FIGS. 3 and 7) discussed throughout the disclosure. The consumer electronic device can comprise a portable electronic device, for example, a smartphone, a tablet, a wearable device, or a laptop.

The glass-based article 701 may be incorporated into another article, for example, an article with a display (or display articles) (e.g., consumer electronics, including mobile phones, tablets, computers, navigation systems, wearable devices (e.g., watches), and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the glass-based article 701 disclosed herein is shown in FIGS. 1-2. Specifically, FIGS. 1-2 show a consumer electronic device 100 including a housing 102 having front 104, back 106, and side surfaces 108. Although not shown, the consumer electronic device can comprise electrical components that are at least partially inside or entirely within the housing. For example, electrical components include at least a controller, a memory, and a display. As shown in FIGS. 1-2, the display 110 can be at or adjacent to the front surface of the housing 102. The consumer electronic device can comprise a cover substrate 112 at or over the front surface of the housing 102 such that it is over the display 110. In aspects, at least one of the cover substrate 112 or a portion of housing 102 may include any of the glass-based article 701 disclosed herein.

Also, FIG. 3 schematically shows a perspective view of a consumer electronic device 301 that is foldable. The consumer electronic device 301 can include the glass-based article 701 in accordance with aspects of the present disclosure. As shown, the consumer electronic device 301 can include a front surface 303 and a side surface 305. The consumer electronic device 301 can include electronic components, including a display 302 that can be viewed through the front surface 303. In aspects, as shown, the consumer electronic device 301 can be folded in a direction 312 to form a folded configuration that brings a first end 327 and a second end 337 (opposite the first end 327) closer together (than in the unfolded configuration). Additionally, as shown, the consumer electronic device 301 can be folded so that the front surface 303 and/or display 302 faces itself, although the consumer electronic device could be folded opposite the direction 312 so that the front surface 303 is on the outside of the consumer electronic device in the folded configuration. The consumer electronic device 301 shown in FIG. 3 can be folded about a fold axis 382, where a central portion 381 is located between a first portion 332 including the first end 327 and a second portion 331 including the second end 337. A location of the fold axis 382 can determine a first distance 313 between the first end 327 and the fold axis 382 (e.g., in direction 306) relative to a second distance 315 between the second end 337 and the fold axis 382 (e.g., in direction 308). A total length of the consumer electronic device can be the sum of the first distance 313 and the second distance 315). A width 307 of the consumer electronic device 301 is measured in direction 304 that is perpendicular to direction 306. Also, as shown, the consumer electronic device is depicted as being in a folded or partially folded configuration with an angle A formed by front surface 303 about the fold axis 382. As shown in FIG. 3, the consumer electronic device 301 can include the glass-based article 701 may include a single fold axis to allow the corresponding article to comprise a bifold wherein, for example, the corresponding article may be folded in half. In further aspects, the consumer electronic device 301 can include the glass-based article 701 may include two or more fold axes, for example, with each fold axis including a corresponding central portion similar or identical to the central portion discussed herein. For example, providing two fold axes can allow the consumer electronic device 301 can include the glass-based article 701 to comprise a trifold wherein, for example, the corresponding article may be folded with the first portion, the second portion, and a third portion similar or identical to the first portion or second portion with the central portion and another central portion similar to or identical to the central portion positioned between the first portion and the second portion and between the second portion and the third portion, respectively.

The glass-based article 701 can comprise a glass-based substrate 511 comprising a glass-based material having a pencil hardness of 8H or more, for example, 9H or more. As used herein, “glass-based” includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Amorphous materials and glass-based materials may be strengthened. As used herein, the term “strengthened” may refer to a material that has been chemically strengthened, for example, through ion exchange of larger ions for smaller ions in the surface of the substrate, as discussed below. However, other strengthening methods, for example, thermal tempering, or utilizing a mismatch of the coefficient of thermal expansion between portions of the substrate to create compressive stress and central tension regions, may be utilized to form strengthened substrates. Exemplary glass-based materials, which may be free of lithia or not, comprise soda lime glass, alkali aluminosilicate glass, alkali-containing borosilicate glass, alkali-containing aluminoborosilicate glass, alkali-containing phosphosilicate glass, and alkali-containing aluminophosphosilicate glass. “Glass-ceramics” include materials produced through controlled crystallization of glass. In aspects, glass-ceramics have about 1% to about 99% crystallinity. Examples of suitable glass-ceramics may include Li₂O—Al₂O₃—SiO₂ system (i.e., LAS-System) glass-ceramics, MgO—Al₂O₃—SiO₂ system (i.e., MAS-System) glass-ceramics, ZnO×Al₂O₃×nSiO₂ (i.e., ZAS system), and/or glass-ceramics that include a predominant crystal phase including β-quartz solid solution, β-spodumene, cordierite, petalite, and/or lithium disilicate. The glass-ceramic substrates may be strengthened using the chemical strengthening processes, as described herein. As used herein, “ceramic-based” includes both ceramics and glass-ceramics, wherein glass-ceramics have one or more crystalline phases and an amorphous, residual glass phase. Ceramic-based materials may be strengthened (e.g., chemically strengthened). In aspects, a ceramic-based material can be formed by heating a glass-based material to form ceramic (e.g., crystalline) portions.

Unless otherwise indicated, glass compositions for glass-based substrates and/or glass-based articles described herein, the concentration of constituent components (e.g., SiO₂, Al₂O₃, Na₂O, and the like) are given in mole percent (mol %) on an oxide basis, unless otherwise specified. Components of the alkali aluminosilicate (e.g., lithium aluminosilicate) glass compositions according to aspects are discussed individually below. It should be understood that any of the variously recited ranges of one component may be individually combined with any of the variously recited ranges for any other component. As used herein, a trailing 0 in a number is intended to represent a significant digit for that number. For example, the number “1.0” includes two significant digits, and the number “1.00” includes three significant digits. Throughout the disclosure, the composition of glass compositions and/or glass articles refers to the composition of the formed article as determined in wt % by: X-ray fluorescence and comparison with standard samples for alumina, phosphorous, alkaline earth metals, transition metals (e.g., ZnO, TiO₂, Fe₂O₃, SnO₂), sodium oxide, and potassium oxide; an amount of B₂O₃ is measured using inductively coupled plasma (ICP) methods; an amount of lithium oxide (Li₂O) is measured using flame emission spectroscopy; and an amount of SiO₂ is taken as the balance of material (i.e., 100%—materials measured using X-ray fluorescence, ICP, and flame emission spectroscopy), and then the composition is converted from wt % to mol %, as reported herein. The composition refers to the composition of the formed article—not the raw materials added to form the glass composition and/or the glass article.

In aspects, the glass-based article 701 and/or the glass-based substrate 511 can comprise lithium and/or be an alkali aluminosilicate glass. In aspects, the composition of the glass-based article 701 and/or the glass-based substrate 511 can comprise, based on 100 mol % of the chemically strengthened glass-based article, from greater than or equal to 40 mol % to less than or equal to 80 mol % SiO₂, from greater than or equal to 0.5 mol % to less than or equal to 30 mol % Al₂O₃, from greater than or equal to 2 mol % to less than or equal to 47 mol % Li₂O and/or R₂O, and optionally: from greater than or equal to 0 mol % to less than or equal to 30 mol % RO; from greater than or equal to 0 mol % to less than or equal to 10 mol % B₂O₃; from greater than or equal to 0 mol % to less than or equal to 15 mol % P₂O₅; and/or from greater than or equal to 0 mol % to less than or equal to 6.0 mol % ZrO₂. As used herein, “RO” refers to a total amount of MgO, CaO, SrO, and BaO. As used herein, “R₂O” refers to a total amount of Li₂O, Na₂O, K₂O, Cs₂O, and Rb₂O. In further aspects, the composition of the glass-based article 701 and/or the glass-based substrate 511 can comprise from greater than or equal to 50 mol % to less than or equal to 75 mol % SiO₂, from greater than or equal to 0.5 mol % to less than or equal to 5 mol % Al₂O₃, from greater than or equal to 20 mol % to less than or equal to 45 mol % Li₂O and/or R₂O, from greater than or equal to 0.0 mol % to less than or equal to 5.0 mol % RO, from greater than or equal to 0.0 mol % to less than or equal to 5 mol % of B₂O₃, from greater than or equal to 0.0 mol % to less than or equal to 6.0 mol % of ZrO₂, and/or from greater than or equal to 0.1 mol % to less than or equal to 3.0 mol % P₂O₅. In even further aspects, the composition of the glass-based article 701 and/or the glass-based substrate 511 can further comprise from greater than or equal to 20 mol % to less than or equal to 45 mol % Li₂O, from greater than or equal to 0.0 mol % to less than or equal to 2.0 mol % Na₂O, and/or from greater than or equal to 0.0 mol % to less than or equal to 1.0 mol % K₂O. In even further aspects, the composition of the glass-based article 701 and/or the glass-based substrate 511 can further comprise from greater than or equal to 20 mol % to less than or equal to 45 mol % Li₂O, from greater than or equal to 0.0 mol % to less than or equal to 0.5 mol % Na₂O, and/or from greater than or equal to 0.0 mol % to less than or equal to 0.3 mol % K₂O. In further aspects, the composition of the glass-based article 701 and/or the glass-based substrate 511 can further comprise from greater than or equal to 20 mol % to less than or equal to 45 mol % Li₂O, from greater than or equal to 0.0 mol % to less than or equal to 2.0 mol % RO, and/or from greater than or equal to 1.0 mol % to less than or equal to 4.0 mol % ZrO₂, and/or from greater than or equal to 0.2 mol % to less than or equal to 3.0 mol % P₂O₅. In further aspects, the composition of the glass-based article 701 and/or the glass-based substrate 511 can be free of B₂O₃. In further aspects, the glass-based article 701 can be free of one or more of TiO₂, ZnO, Ta₂O₅, HfO₂, La₂O₃, and/or Y₂O₃. Unless otherwise indicated, as used herein, the term “free” does not require absolute precision nor atomic-scale accuracy, but rather “free” means that the component may be present in the final glass-based composition in very small amounts (e.g., as a contaminant, such as less than 0.1 mol %) that could be practically obtained by a reasonable practitioner, which does include 0.0 mol % in some aspects. For example, the inclusion of Ta₂O₅, HfO₂, La₂O₃, and/or Y₂O₃ may increase the cost of raw materials associated with the glass substrate.

In aspects, the glass-based article 701 can be optically transparent. As used herein, “transparent,” “optically transparent,” or “optically clear” means an average transmittance of 70% or more in the wavelength range of 400 nm to 700 nm through a 1.0 mm thick piece of a material. In aspects, an “optically transparent material” or an “optically clear material” may have an average transmittance of 75% or more, 80% or more, 85% or more, or 90% or more, 92% or more, 94% or more, 96% or more in the wavelength range of 400 nm to 700 nm through a 1.0 mm thick piece of the material. The average transmittance in the wavelength range of 400 nm to 700 nm is calculated by measuring the transmittance of whole number wavelengths from 400 nm to 700 nm and averaging the measurements.

Throughout the disclosure, the Young's modulus of glass materials is measured using the resonant ultrasonic spectroscopy technique set forth in ASTM E2001-13, titled “Standard Guide for Resonant Ultrasound Spectroscopy for Defect Detection in Both Metallic and Non-metallic Parts.” In aspects, the glass-based article 701 can comprise an elastic modulus of 50 GPa or more, 60 GPa or more, 65 GPa or more, 70 GPa or more, 72 GPa or more, 75 GPa or more, 120 GPa or less, 100 GPa or less, 90 GPa or less, 80 GPa or less, 75 GPa or less, 72 GPa or less, or 70 GPa or less. In further aspects, the glass-based article 701 can comprise a glass material comprising an elastic modulus ranging from 50 GPa to 120 GPa, from 60 GPa to 100 GPa, from 65 GPa to 90 GPa, from 70 GPa to 80 GPa, from 72 GPa to 75 GPa, or any range or subrange therebetween.

As shown in FIG. 7, the glass-based article 701 can comprise a first major surface 503 and a second major surface 505 opposite the first major surface 503. In aspects, the first major surface 503 can extend along a first plane, and/or the second major surface 505 can extend along a second plane. In further aspects, the second plane (second major surface 505) can be parallel to the first plane (first major surface 503). As used herein, an article thickness 709 of the glass-based article 701 is defined between the first major surface 503 and the second major surface 505 as an average distance therebetween. In aspects, the article thickness 709 can be 30 micrometers (μm) or more, 40 μm or more, 50 μm or more, 60 μm or more, 80 μm or more, 100 μm or more, 300 μm or more, 500 μm or more, 1 millimeter (mm) or more, 3 mm or less, 2 mm or less, 1 mm or less, 800 μm or less, 600 μm or less, 400 μm or less, 300 μm or less, 250 μm or less, 200 μm or less, 160 μm or less, 120 μm or less, 100 μm or less, 80 μm or less, 60 μm or less, 50 μm or less, or 40 μm or less. In aspects, the article thickness 709 can be from greater than or equal to 30 μm to less than or equal to 3 mm, from greater than or equal to 40 μm to less than or equal to 2 mm, from greater than or equal to 60 μm to less than or equal to 1 mm, from greater than or equal to 80 μm to less than or equal to 800 μm, from greater than or equal to 100 μm to less than or equal to 600 μm, from greater than or equal to 300 μm to less than or equal to 400 μm, or any range or subrange therebetween. In aspects, the glass-based article 701 can be an ultra-thin substrate, meaning that the article thickness 709 is 300 micrometers or less, for example, from greater than or equal to 30 μm to less than or equal to 300 μm, from greater than or equal to 40 μm to less than or equal to 250 μm, from greater than or equal to 50 μm to less than or equal to 200 μm, from greater than or equal to 60 μm to less than or equal to 160 μm, from greater than or equal to 80 μm to less than or equal to 100 μm, or any range or subrange therebetween. In aspects, as shown, a local thickness of the glass-based article 701 can be substantially uniform (e.g., substantially equal to the article thickness 709) across the first major surface 503 and/or the second major surface 505.

The glass-based article 701 can comprise one or more compressive stress regions. In aspects, a compressive stress region may be created by chemically strengthening. Chemically strengthening may comprise an ion exchange process, where ions in a surface layer are replaced by—or exchanged with—larger ions having the same valence or oxidation state. Methods of chemically strengthening will be discussed later. Without wishing to be bound by theory, chemically strengthening the glass-based article to form the glass-based article 701 can enable good impact and/or puncture resistance (e.g., resists failure for a pen drop height of 20 centimeters). Without wishing to be bound by theory, chemically strengthening the glass-based article can enable small (e.g., 10 mm or less) bend radii because the compressive stress from the chemical strengthening can counteract the bend-induced tensile stress on the outermost surface of the substrate. A compressive stress region may extend into a portion of the first portion and/or second portion for a depth called the depth of compression. As used herein, depth of compression means the depth at which the stress in the chemically-strengthened substrates and/or portions described herein changes from compressive stress to tensile stress. Depth of compression may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the substrate and/or portion is generated by exchanging potassium ions into the substrate, a surface stress meter, for example, the FSM-6000 (Orihara Industrial Co., Ltd. (Japan)), is used to measure depth of compression. Unless specified otherwise, compressive stress (including surface CS) is measured by surface stress meter (FSM) using commercially available instruments, for example the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than 400 μm, SCALP is used to measure the depth of compression and central tension (CT). Where the stress in the substrate and/or portion is generated by exchanging both potassium and sodium ions into the substrate and/or portion, and the article being measured is thicker than 400 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the substrate and/or portion (e.g., sodium, potassium). Through the disclosure, when the maximum central tension cannot be measured directly by SCALP (as when the article being measured is thinner than 400 μm) the maximum central tension can be approximated by a product of a maximum compressive stress and a depth of compression divided by the difference between the thickness of the substrate and twice the depth of compression, wherein the compressive stress and depth of compression are measured by FSM. Throughout the disclosure, an absolute value of compressive stress is reported as compressive stress, and an absolute value of central tensile stress is reported as central tensile stress.

In aspects, as shown in FIG. 7, the first major surface 503 of the glass-based article 701 can comprise a first compressive stress region 702 extending to a first depth of compression 713 from the first major surface 503. Although not shown, the first compressive stress region 702 can also comprise a first depth of layer of one or more alkali metal ions (e.g., potassium) associated with the first compressive stress region. In aspects, as shown in FIG. 7, the second major surface 505 of the glass-based article 701 can comprise a second compressive stress region 704 extending to a second depth of compression 715 from the second major surface 505. Although not shown, the second compressive stress region 704 can also comprise a second depth of layer of one or more alkali metal ions (e.g., potassium) associated with the first compressive stress region. As shown in FIG. 7, dashed lines 723 and 725 correspond to locations where a stress in the (chemically strengthened) glass-based article switches from compressive to tensile (or visa versa) corresponding to a boundary (i.e., depth of compression) of the corresponding compressive stress region.

In aspects, the first depth of compression 713 and/or the second depth of compression 715 as a percentage of the article thickness 709 can be 5% or more, 10% or more, 12% or more, 14% or more, 16% or more, 18% or more, 20% or more, 30% or less, 26% or less, or 22% or less, 20% or less, 19% or less, 18% or less, 17% or less, or 16% or less. In aspects, the first depth of compression 713 and/or the second depth of compression 715 as a percentage of the article thickness 709 can range from 5% to 30%, from 10% to 26%, from 12% to 22%, from 14% to 20%, from 16% to 19%, from 16% to 19%, from 16% to 18%, or any range or subrange therebetween. In aspects, the first depth of compression 713 and/or the second depth of compression 715 as a percentage of the article thickness 709 can be 15% or more, for example, from 16% to 30%, from 16% to 26%, from 18% to 24%, from 20% to 22%, or any range or subrange therebetween. In exemplary aspects, the first depth of compression 713 and/or the second depth of compression 715 as a percentage of the article thickness 709 can be from 10% to 30%, from 16% to 26%, or from 20% to 22%. In aspects, the first depth of compression 713 and/or the second depth of compression 715 can be 5 μm or more, 10 μm or more, 25 μm or more, 50 μm or more, 75 μm or more, 100 μm or more, 120 μm or more, 150 μm or more, 400 μm or less, 300 μm or less, 250 μm or less, 200 μm or less, 150 μm or less, 130 μm or less, 100 μm or less, 80 μm or less, 50 μm or less, 30 μm or less, 20 μm or less, or 10 μm or less. In aspects, the first depth of compression 713 and/or the second depth of compression 715 can be from 5 μm to 500 μm, from 10 μm to 400 μm, from 25 μm to 300 μm, from 50 μm to 250 μm, from 75 μm to 200 μm, from 100 μm to 150 μm, from 120 μm to 130 μm, or any range or subrange therebetween. In exemplary aspects, the first depth of compression 713 and/or the second depth of compression 715 can be from 5 μm to 400 μm, from 100 μm to 250 μm, or from 100 μm to 150 μm. In aspects, the first depth of compression 713 and/or the second depth of compression 715 can be from greater than or equal to 5 μm to less than or equal to 30% of the substrate thickness, from greater than or equal to 25 μm to less than or equal to 25% of the substrate thickness, from greater than or equal to 50 μm to less than or equal to 20% of the substrate thickness, from greater than or equal to 100 μm to less than or equal to 18% of the substrate thickness, from greater than or equal to 120 μm to less than or equal to 15% of the substrate thickness, or any range or subrange therebetween.

In aspects, the first depth of layer and/or the second depth of layer of one or more alkali metal ions (e.g., potassium) as a percentage of the article thickness 709 can be 5% or more, 10% or more, 12% or more, 14% or more, 16% or more, 18% or more, 20% or more, 30% or less, 26% or less, or 22% or less, 20% or less, 19% or less, 18% or less, 17% or less, or 16% or less. In aspects, the first depth of layer and/or the second depth of layer of one or more alkali metal ions (e.g., potassium) as a percentage of the article thickness 709 can range from 5% to 30%, from 10% to 26%, from 12% to 22%, from 14% to 20%, from 16% to 19%, from 17% to 18%, or any range or subrange therebetween. In aspects, the first depth of layer and/or the second depth of layer of one or more alkali metal ions (e.g., potassium) as a percentage of the article thickness 709 can be 15% or more, for example, from 16% to 30%, from 16% to 26%, from 18% to 24%, from 20% to 22%, or any range or subrange therebetween. In preferred aspects, the first depth of layer and/or the second depth of layer of one or more alkali metal ions (e.g., potassium) as a percentage of the article thickness 709 can be from 10% to 30%, from 12% to 19%, or from 16% to 26%. In aspects, the first depth of layer and/or the second depth of layer of one or more alkali metal ions (e.g., potassium) can be 3 μm or more, 5 μm or more, 7 μm or more, 10 μm or more, 15 μm or more, 20 μm or more, 25 μm or more, 30 μm or more, 50 μm or more, 70 μm or more, 100 μm or more, 120 μm or more, 150 μm or more, 400 μm or less, 300 μm or less, 250 μm or less, 200 μm or less, 150 μm or less, 130 μm or less, 100 μm or less, 60 μm or less, 50 μm or less, 40 μm or less, 30 μm or less, 25 μm or less, 20 μm or less, 15 μm or less, 10 μm or less, or 8 μm or less. In aspects, the first depth of layer and/or the second depth of layer of one or more alkali metal ions (e.g., potassium) can be from 3 μm to 400 μm, from 5 μm to 300 μm, from 7 μm to 250 μm, from 10 μm to 200 μm, from 15 μm to 150 μm, from 20 μm to 130 μm, from 25 μm to 100 μm, from 30 μm to 60 μm, from 50 μm to 60 μm, or any range or subrange therebetween. In exemplary aspects, the first depth of layer and/or the second depth of layer of one or more alkali metal ions (e.g., potassium) can be from 5 μm to 400 μm, from 25 μm to 250 μm, or from 100 μm to 150 μm.

In aspects, the first compressive stress region 702 can comprise a first maximum compressive stress and/or the second compressive stress region 704 can comprise a second maximum compressive stress. In further aspects, the first maximum compressive stress can be substantially equal to the second maximum compressive stress. In further aspects, the first maximum compressive stress and/or second maximum compressive stress can be 350 MegaPascals (MPa) or more, 400 MPa or more, 450 MPa or more, 500 MPa or more, 600 MPa or more, 700 MPa or more, 800 MPa or more, 900 MPa or more, 1000 MPa or more, 1100 MPa or more, 1,500 MPa or less, 1,300 MPa or less, 1,250 MPa or less, 1,200 MPa or less, 1,150 MPa or less, 1,100 MPa or less, 1,050 MPa or less, 1,000 MPa or less, 950 MPa or less, 900 MPa or less, 850 MPa or less, 800 MPa or less, 750 MPa or less, 700 MPa or less, 650 MPa or less, 600 MPa or less, 550 MPa or less, or 500 MPa or less. In further aspects, the first maximum compressive stress and/or second maximum compressive stress can be from greater than or equal to 350 MPa to less than or equal to 1500 MPa, from greater than or equal to 400 MPa to less than or equal to 1300 MPa, from greater than or equal to 450 MPa to less than or equal to 1250 MPa, from greater than or equal to 500 MPa to less than or equal to 1200 MPa, from greater than or equal to 600 MPa to less than or equal to 1150 MPa, from greater than or equal to 700 MPa to less than or equal to 1100 MPa, from greater than or equal to 800 MPa to less than or equal to 1050 MPa, from greater than or equal to 900 MPa to less than or equal to 1000 MPa, or any range or subrange therebetween. In preferred aspects, the first maximum compressive stress and/or second maximum compressive stress can be from greater than or equal to 350 MPa to less than or equal to 1500 MPa, from greater than or equal to 400 MPa to less than or equal to 1000 MPa, from greater than or equal to 450 MPa to less than or equal to 750 MPa, or any range or subrange therebetween.

In aspects, a compressive stress can be elevated at depths greater than those typically achieved from a potassium spike in a multi-step ion-exchange process-due to the addition of the phosphate salt in accordance with methods of the present disclosure. In further aspects, a compressive stress at a depth of 40 μm from the first major surface can be greater than or equal to 150 MPa, greater than or equal to 180 MPa, greater than or equal to 200 MPa, greater than or equal to 220 MPa, greater than or equal to 250 MPa, less than or equal to 800 MPa, less than or equal to 600 MPa, less than or equal to 400 MPa, less than or equal to 300 MPa, or less than or equal to 250 MPa. In further aspects, a compressive stress at a depth of 40 μm from the first major surface can be from greater than or equal to 150 MPa to less than or equal to 800 MPa, from greater than or equal to 180 MPa to less than or equal to 600 MPa, from greater than or equal to 200 MPa to less than or equal to 400 MPa, from greater than or equal to 220 MPa to less than or equal to 300 MPa, from greater than or equal to 220 MPa to less than or equal to 250 MPa, or any range or subrange therebetween. In aspects, a compressive stress (CS) at a depth of 40 μm from the first major surface as a percentage of the maximum compressive stress (e.g., at the first major surface—CS(40 μm)/CS(0 μm)×100%) can be 45% or more, 47% or more, 50% or more, 52% or more, 55% or more 57% or more, 60% or more, 63% or more, 66% or more, 75% or less, 70% or less, 66% or less, 63% or less, 60% or less, 57% or less, 55% or less, 52% or less or 50% or less. In aspects, a compressive stress at a depth of 40 μm from the first major surface as a percentage of the maximum compressive stress can be from greater than or equal to 45% to less than or equal to 75%, from greater than or equal to 47% to less than or equal to 70%, from greater than or equal to 50% to less than or equal to 66%, from greater than or equal to 52% to less than or equal to 60%, from greater than or equal to 55% to less than or equal to 57%, or any range or subrange therebetween. In aspects, a compressive stress at 25% of the depth of compression (DOC) from the first major surface as a percentage of the maximum compressive stress (e.g., at the first major surface—CS(0.25×DOC)/CS(0 μm)×100%) can be within one or more of the ranges for percentages discussed above in this paragraph.

In further aspects, a compressive stress at a depth of 20 μm from the first major surface can be greater than or equal to 200 MPa, greater than or equal to 220 MPa, greater than or equal to 250 MPa, greater than or equal to 270 MPa, greater than or equal to 300 MPa, less than or equal to 800 MPa, less than or equal to 600 MPa, less than or equal to 500 MPa, less than or equal to 400 MPa, or less than or equal to 350 MPa. In further aspects, a compressive stress at a depth of 20 μm from the first major surface can be from greater than or equal to 200 MPa to less than or equal to 800 MPa, from greater than or equal to 220 MPa to less than or equal to 600 MPa, from greater than or equal to 250 MPa to less than or equal to 500 MPa, from greater than or equal to 270 MPa to less than or equal to 400 MPa, from greater than or equal to 300 MPa to less than or equal to 350 MPa, or any range or subrange therebetween. In aspects, a compressive stress (CS) at a depth of 20 μm from the first major surface as a percentage of the maximum compressive stress (e.g., at the first major surface—CS(20 μm)/CS(0 μm)×100%) can be 50% or more, 55% or more, 60% or more, 63% or more, 66% or more 70% or more, 73% or more, 75% or more, 77% or more, 80% or more, 83% or more, 85% or more, 90% or less, 87% or less, 85% or less, 83% or less, 80% or less, 77% or less, 75% or less, 72% or less, 70% or less, 66% or less, 63% or less, or 60% or less. In aspects, a compressive stress at a depth of 20 μm from the first major surface as a percentage of the maximum compressive stress can be from greater than or equal to 50% to less than or equal to 90%, from greater than or equal to 55% to less than or equal to 87%, from greater than or equal to 60% to less than or equal to 85%, from greater than or equal to 63% to less than or equal to 83%, from greater than or equal to 66% to less than or equal to 80%, from greater than or equal to 70% to less than or equal to 77%, from greater than or equal to 73% to less than or equal to 75%, or any range or subrange therebetween. In aspects, a compressive stress at 13% of the depth of compression (DOC) from the first major surface as a percentage of the maximum compressive stress (e.g., at the first major surface—CS(0.13×DOC)/CS(0 μm)×100%) can be within one or more of the ranges for percentages discussed above in this paragraph.

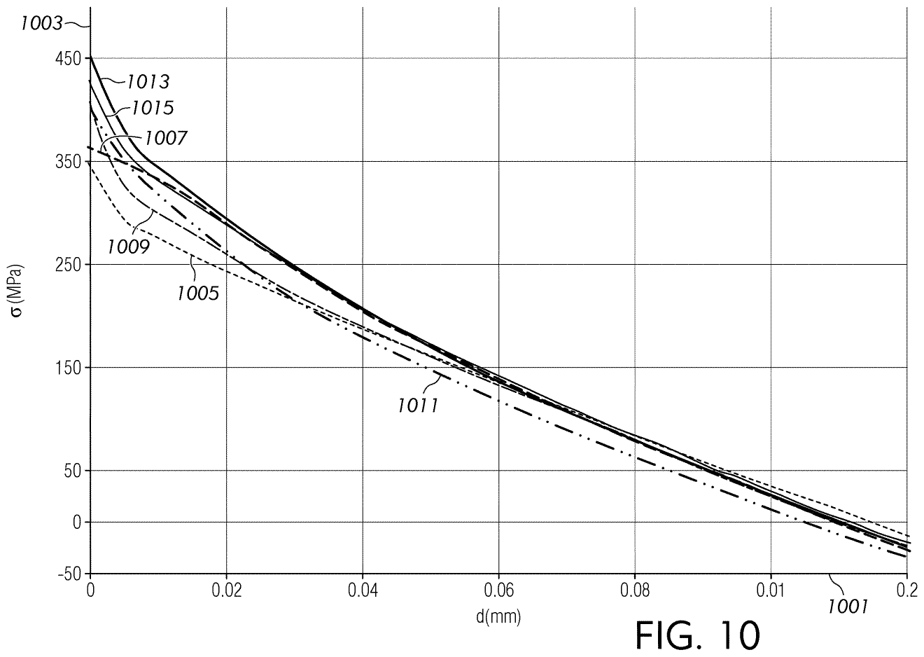

For example, FIG. 10 illustrates stress profiles having compressive stress (6) in MegaPascals (MPa) on the vertical axis 1003 (i.e., y-axis) as a function of depth (d) from the first major surface in millimeters (mm) on the horizontal axis 1001 (i.e., x-axis). Curves 1005 and 1007 correspond to Comparative Examples AA-BB (discussed below), respectively, without the addition of the phosphate salt during the chemical strengthening process while curves 1009, 1011, 1013, and 1015 correspond to Examples 1-4 (discussed below), respectively, where phosphate salt was added during the chemical strengthening process. As shown, the maximum compressive stress (at the first major surface) is greater than or equal to 350 MPa for curves 1009, 1011, 1013, and 1015. Also, the compressive stress a depth of 20 μm (0.02 mm) from the first major surface is greater than or equal to 250 MPa for curves 1009, 1011, 1013, and 1015, which is from about 50% to about 70% of the maximum compressive stress (at the first major surface).

Throughout the disclosure, the Ring-on-Ring (ROR) test is a surface strength measurement for testing flat glass specimens, and ASTM C1499-19, entitled “Standard Test Method for Monotonic Equibiaxial Flexural Strength of Advanced Ceramics at Ambient Temperature,” serves as the basis for the ROR test methodology described herein. The contents of ASTM C1499-09 are incorporated herein by reference in their entirety. The sample is placed between two concentric rings of differing size to determine equibiaxial flexural strength (i.e., the maximum stress that a material is capable of sustaining when subjected to flexure between two concentric rings) with the sample supported by a support ring with diameter D2. A force F is applied by a load cell to the surface of the glass-based article by a loading ring having a diameter D1. Unless otherwise indicated, a ratio of D1/D2 is 0.5. The loading and the support ring were aligned concentrically to within 0.5% of support ring diameter D2. The load cell used for testing is accurate to within ±1% at any load within a selected range. Testing is carried out at a temperature of 23±2 °C and a relative humidity of 40±10%. For fixture design, the radius r of the protruding surface of the loading ring is in a range of h/2≤r≤3 h/2, where h is the thickness of sample. Loading and support rings are made of hardened steel with hardness HRc>40. The intended failure mechanism for the ROR test is to observe fracture of the sample originating from a region of the surface of the sample within both loading rings. Failures that occur outside of this region—i.e., between the loading ring and support ring—are omitted from data analysis. Due to the thinness and high strength of the sample, however, large deflections that exceed ½ of the sample thickness h are sometimes observed. It is therefore not uncommon to observe a high percentage of failures originating from underneath the loading ring. Stress cannot be accurately calculated without knowledge of stress development both inside and under the ring (collected via strain gauge analysis) and the origin of failure in each specimen. ROR testing therefore focuses on peak load at failure as the measured response.

As used herein, samples were prepared for used in the ROR test as follows: a circular region having a diameter of ⅛ inch (3.175 mm) on the first major surface of the sample is abraded with 90 grit SiC to generate flaw depths based on the pressure (from 1 pound-per-square inch (psi) (X) to 15 psi (X)) and the sample was held at 23 °C in a 50% relative humidity environment before being tested. Flaw depth induced by abrasion with the 90 grit SiC is measured as the depth from the first major surface that cracks extend into the sample immediately before the ROR testing using microscopy. As used herein, “failure strength”, “retained strength”, and “ring-on-ring strength” refer to the strength measured using the ROR test. In aspects, a retained strength (i.e., failure strength) of the glass-based article at a flaw depth of 40 μm can be greater than or equal to 500 MPa, greater than or equal to 550 MPa, greater than or equal to 600 MPa, greater than or equal to 650 MPa, greater than or equal to 700 MPa, greater than or equal to 750 MPa, less than or equal to 1000 MPa, less than or equal to 900 MPa, less than or equal to 850 MPa, less than or equal to 800 MPa, or less than or equal to 750 MPa. In aspects, a retained strength (i.e., failure strength) of the glass-based article at a flaw depth of 40 μm can be from greater than or equal to 500 MPa to less than or equal to 1000 MPa, from greater than or equal to 550 MPa to less than or equal to 900 MPa, from greater than or equal to 600 MPa to less than or equal to 850 MPa, from greater than or equal to 650 MPa to less than or equal to 800 MPa, from greater than or equal to 700 MPa to less than or equal to 750 MPa, or any range or subrange therebetween. In aspects, a retained strength (i.e., failure strength) of the glass-based article at a flaw depth of 20 μm can be greater than or equal to 800 MPa, greater than or equal to 900 MPa, greater than or equal to 950 MPa, greater than or equal to 1000 MPa, greater than or equal to 1050 MPa, less than or equal to 1250 MPa, less than or equal to 1200 MPa, less than or equal to 1150 MPa, less than or equal to 1100 MPa, less than or equal to 1050 MPa, or less than or equal to 1000 MPa. In aspects, a retained strength (i.e., failure strength) of the glass-based article at a flaw depth of 20 μm can be from greater than or equal to 800 MPa to less than or equal to 1250 MPa, from greater than or equal to 900 MPa to less than or equal to 1200 MPa, from greater than or equal to 950 MPa to less than or equal to 1150 MPa, from greater than or equal to 1000 MPa to less than or equal to 1100 MPa, or any range or subrange therebetween. In aspects, a retained strength (i.e., failure strength) (or) of the glass-based article at a flaw depth of 40 μm, as a percentage of the retained strength at a flaw depth of 20 μm, (i.e., or (40 μm)/or (20 μm)×100%) can be 50% or more, 55% or more, 60% or more, 66% or more, 70% or more, 75% or more, 80% or more, 90% or less, 85% or less, 80% or less, 75% or less, 70% or less, or 66% or less. aspects, a retained strength (i.e., failure strength) (or) of the glass-based article at a flaw depth of 40 μm, as a percentage of the retained strength at a flaw depth of 20 μm, can be from greater than or equal to 50% to less than or equal to 90%, from greater than or equal to 55% to less than or equal to 85%, from greater than or equal to 60% to less than or equal to 80%, from greater than or equal to 66% to less than or equal to 75%, from greater than or equal to 70% to less than or equal to 75%, or any range or subrange therebetween.

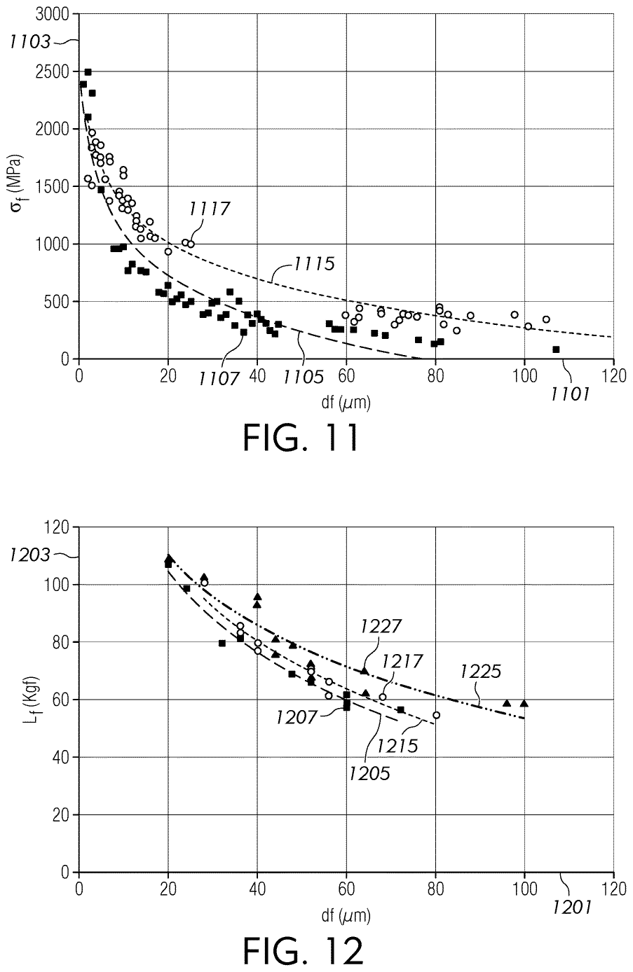

For example, FIGS. 11-12 illustrate a relationship between failure stress (of) in MegaPascals (MPa) on the vertical axis 1103 (i.e., y-axis) or failure load (Lf) on the vertical axis 1203 (i.e., y-axis) as a function of flaw depth (df) in micrometers (μm) on the horizontal axis 1101 or 1201 (i.e., x-axis) using the Ring-on-Ring Test. As shown in FIG. 11, curve 1105 shows the trend for points 1107 of Comparative Example CC (discussed below) without the addition of the phosphate salt during the chemical strengthening process without while curve 1115 shows the trend for points 1117 for Examples 5-6 (combined-discussed below), where phosphate salt was added during the chemical strengthening process. For extremely small flaw depths (e.g., df<10 μm), the curves 1105 and 1115 (and/or points 1107 and 1117) substantially overlap. However, at flaw depths from about 10 μm to about 60 μm, curve 1115 is above curve 1105. For example, at a flaw depth of 40 μm, curve 1115 is about 750 MPa while curve 1105 is less than 400 MPa. Likewise, at a flaw depth of 20 μm, curve 1105 is about 1000 MPa while curve 1105 is less than 750 MPa. Further, a ratio of the failure strength at 40 μm to the failure strength at 20 μm (as a percentage) for curve 1115 is about 75%. In contrast, the corresponding ratio of curve 1105 is less than 60%. Consequently, the methods of present disclosure enable increased retained strength for flaw depths (e.g., from 20 μm to 60 μm). In aspects, methods of the present disclosure adding a phosphate salt to the molten salt bath during the chemical strengthening can produce a glass-based article that exhibits a retained strength that is greater than or equal to a corresponding retained strength of a comparative article chemically strengthened without the addition of a phosphate salt during the chemical strengthening process but otherwise the same—the same bulk composition, the same initial composition of the molten salt solution, and the same temperature and time for the chemical strengthening treatment.

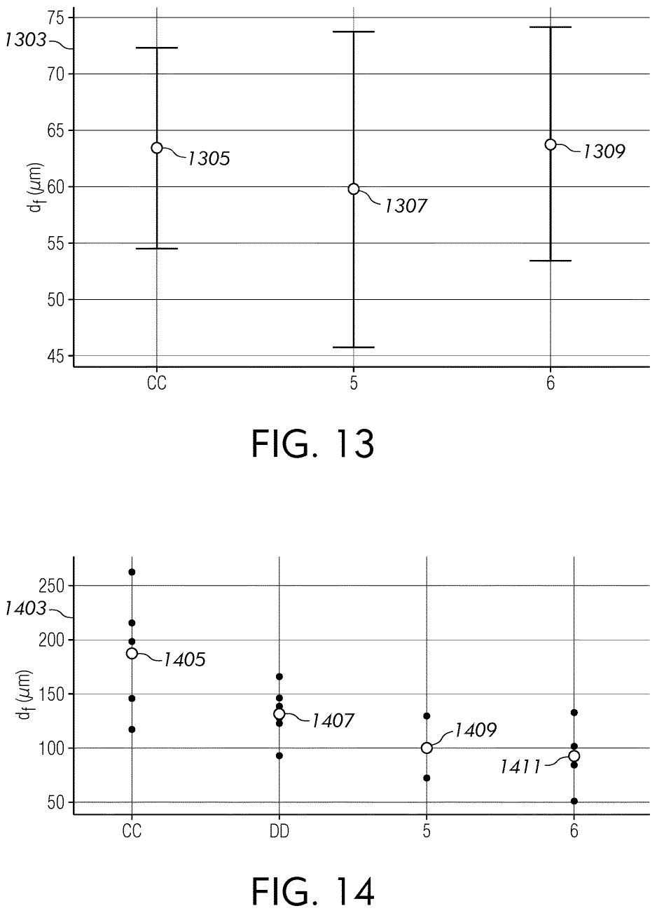

As used herein, the “Slapper Test” is preformed using sand-paper impact via a slapper having a predetermined grit. Unless otherwise indicated, the sand paper had a grit of 80 (as for the results presented in FIG. 13 but the results in FIG. 14 used sandpaper with a grit of 30). Testing was performed using an apparatus comprising a simple pendulum-based dynamic impact test having a surface ranging from flat to curved, where the glass-based article test specimen is mounted to a bob of a pendulum, which is then used to cause the test specimen to contact a roughened impact surface. The apparatus is described in detail in U.S. Pat. No. 11,131,611 B2, which is hereby incorporated by reference in its entirety. To perform the Slapper Test, the sample is loaded on the holder and then pulled backwards from the pendulum equilibrium position and released to make a dynamic impact on the impact surface (forming the “damaged sample” referred to below). The impact surface is a 20 mm square piece of 80-grit sandpaper. After the sand-paper impact on the glass-based article, the strength of the glass-based article is measured as applied fracture stress to failure with a 4-Point Bending Test in accordance with ASTM C158 entitled “Standard Test Methods for Strength of Glass by Flexure (Determination of Modulus of Rupture.” Specifically, in the 4-Point Bending Test as part of the Slapper Test, the damaged sample was placed on support rods (support span or 30 mm) with the damaged site on the bottom (i.e., on the tension side) and between the load roads (loading span of 15 mm). Loading was done at a constant displacement rate of 5 mm/min using a screw-driven testing machine (available from Instron-Norwood, Massachusetts, USA) until failure of the damaged sample. The applied fracture stress of (i.e., applied stress to failure) in the 4-Point Bending Test is calculated using the following equation: σf=3P(L−a)/(2bh²), where “P” is the maximum load to failure, “L” is the support span (30 mm), “a” is the loading span (15 mm), “b” is the width of the damaged sample, and “h” is the thickness of the damaged sample. The fracture is assumed to be a mode I failure (i.e., crack opening). Flaw depth imparted by the sand-paper impact is measured as described above with reference to the ROR test. For a glass-based article tested in the Slapper Test, a smaller effective flaw depth represents a more damage resistant glass-based article since the glass-based article was able to prevent a larger effective flaw depth from forming due to the dynamic impact on the sandpaper.

In aspects, an effective flaw depth for the glass-based article 701 in a Slapper test (using sandpaper with 80 grit and/or 30 grit) can be less than or equal to 150 μm, less than or equal to 140 μm, less than or equal to 135 μm, less than or equal to 130 μm, less than or equal to 125 μm, less than or equal to 120 μm, less than or equal to 110 μm, less than or equal to 100 μm, less than or equal to 90 μm, less than or equal to 80 μm, less than or equal to 75 μm, less than or equal to 70 μm, less than or equal to 65 μm, or less than or equal to 60 μm. In aspects, an effective flaw depth for the glass-based article 701 in a Slapper test (using sandpaper with 80 grit and/or 30 grit) can be from greater than or equal to 50 μm to less than or equal to 150 μm, from greater than or equal to 55 μm to less than or equal to 140 μm, from greater than or equal to 60 μm to less than or equal to 135 μm, from greater than or equal to 65 μm to less than or equal to 130 μm, from greater than or equal to 70 μm to less than or equal to 125 μm, from greater than or equal to 75 μm to less than or equal to 120 μm, from greater than or equal to 80 μm to less than or equal to 110 μm, from greater than or equal to 85 μm to less than or equal to 100 μm, or any range or subrange therebetween. In further aspects, an effective flaw depth for the glass-based article 701 in a Slapper test (using sandpaper with 80 grit) can be from greater than or equal to 50 μm to less than or equal to 140 μm, from greater than or equal to 55 μm to less than or equal to 75 μm, or from greater than or equal to 57 μm to less than or equal to 60 μm. In further aspects, an effective flaw depth for the glass-based article 701 in a Slapper test (using sandpaper with 30 grit) can be from greater than or equal to 50 μm to less than or equal to 140 μm, from greater than or equal to 75 μm to less than or equal to 135 μm, or from greater than or equal to 90 μm to less than or equal to 100 μm.

FIGS. 13-14 illustrate flaw depth (df) in micrometers (μm) on the vertical axis 1303 or 1403 (i.e., y-axis) for Examples 5-6 and Comparative Example CC-DD as measured in the Slapper Test using an 80 grit slapper (FIG. 13) or a 30 grit slapper (FIG. 14). As discussed below, Comparative Examples CC-DD were chemically strengthened without the addition of a phosphate salt while Examples 5-6 had a phosphate salt added to the molten salt solution during the chemical strengthening process. As shown in FIG. 13, the effective flaw depth was about 60 μm with the error bars overlapping for Examples 5-6 and Comparative Example CC. As shown in FIG. 14, Comparative Example CC had the worst performance with an effective flaw depth of 188 μm, followed by Comparative Example DD that had an effective flaw depth of 132 μm; Examples 5-6 had effective flaw depths of 101 μm and 93 μm, respectively. In particular, the effective flaw depth for Example 5-6 is much lower than the effective flaw depth for Comparative Example CC, which demonstrates that Examples 5-6 are better able to prevent the larger flaw depths seen in Comparative Example CC from forming.

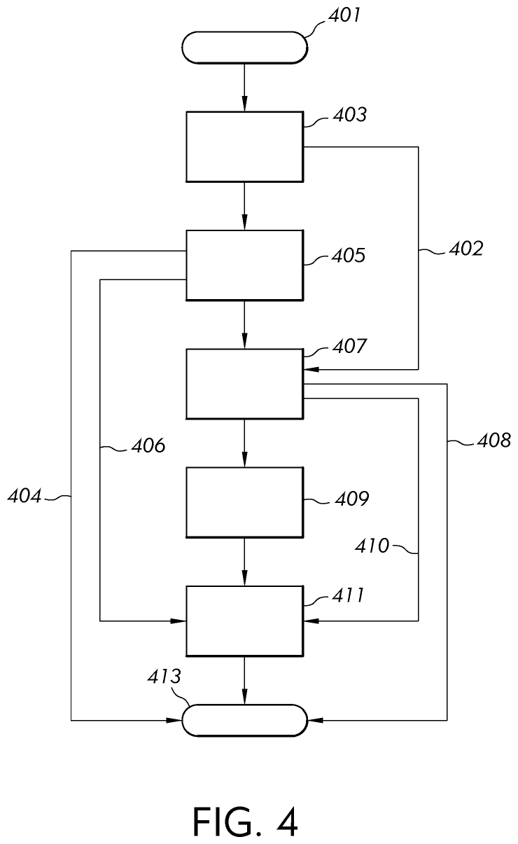

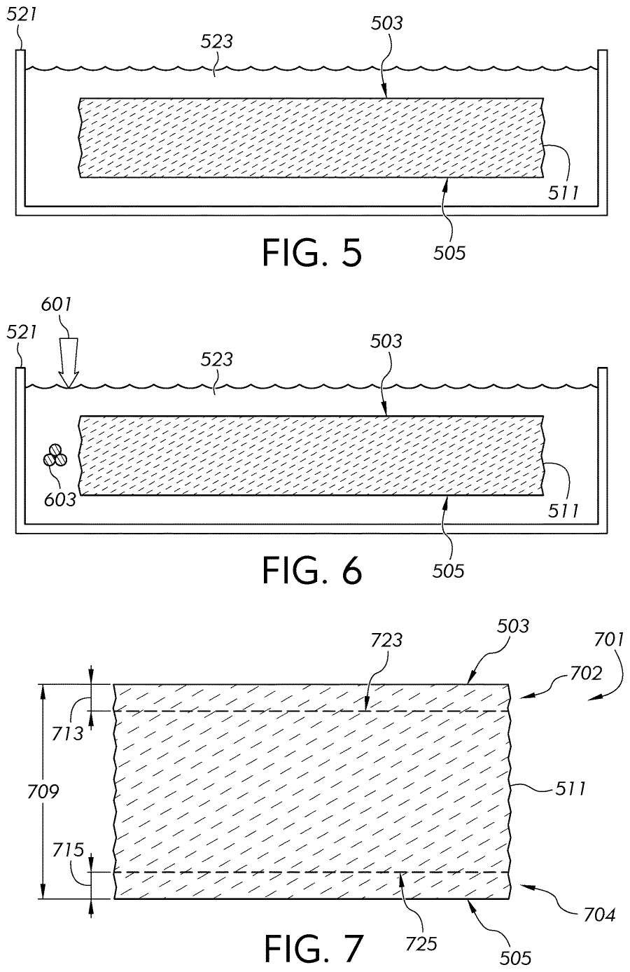

Aspects of methods of chemically strengthening a glass-based substrate to form the glass-based article 701 in accordance with aspects of the disclosure, will be discussed with reference to the flow chart in FIG. 4 and example method steps illustrated in FIGS. 5-6 and 8-9 along with the cross-sectional view illustrated in FIG. 7 for the glass-based article 701.

Methods of the present disclosure will now be discussed with reference to FIGS. 3-4. In aspects, methods can start with providing raw materials. For example, as shown, the raw materials can correspond to the batch material. The raw materials can comprise individual chemicals and/or materials (e.g., clays) that are mixed together to form the batch material. The composition of the raw materials and/or the batch material can be within one or more of the corresponding compositions ranges discussed above with reference to the composition of the glass composition and/or the glass article.

In a first step 401 of methods of the disclosure, methods can start with providing a glass-based substrate 511, as shown in FIGS. 5-6. In aspects, the glass-based substrate 511 may be provided by purchase or otherwise obtaining a substrate or by forming the glass-based article. In aspects, the glass-based substrate 511 can comprise a glass substrate. In further aspects, glass substrates can be provided by forming them with a variety of ribbon forming processes, for example, slot draw, down-draw, fusion down-draw, up-draw, press roll, redraw, or float. The glass-based substrate 511 may comprise a first major surface 503 and a second major surface 505 opposite the first major surface 503. In further aspects, a thickness (e.g., see article thickness 709 in FIG. 9) of the glass-based substrate 511 (defined as an average distance between the first major surface 503 and the second major surface 505) can be within one or more of the ranges discussed above and/or may be within 5 μm of the final thickness (e.g., article thickness 709). In further aspects, the first major surface 503 and/or the second major surface 505 can extend along a plane. In aspects, the glass-based substrate 511 can have a composition within one or more of the ranges discussed above for the glass-based substrate 511 and/or the glass-based article 701. In aspects, at the end of step 401, the glass-based substrate 511 can be unstrengthened. As used herein, unstrengthened refers to a substrate comprising either no depth of layer, no depth of compression, a depth of layer from 0% to 5% of the substrate thickness, or a depth of compression from 0% to 5% of the substrate thickness and/or article thickness. In aspects, at the end of step 401, the glass-based substrate 511 can comprise lithium and/or a composition within one or more of the corresponding compositional ranges discussed above for the composition of the glass-based substrate 511 and/or the glass-based article 701. In further aspects, the glass-based substrate can comprise an lithium aluminosilicate glass composition, although other compositions are provided in other aspects, as discussed above.

In aspects, after step 401, methods can proceed to step 403 comprising contacting at least the first major surface 503 of the glass-based substrate 511 with a molten salt solution 523 maintained at a first temperature for a first period of time to develop a compressive stress region (e.g., a first compressive stress region extending from the first major surface to a depth of compression), as shown in FIG. 5. In further aspects, properties of an initial compressive stress region (e.g., maximum compressive stress, depth of compression, depth of layer) can be within one or more of the corresponding ranges discussed above. In aspects, as shown in FIG. 5, the molten salt solution 523 can be contained in a molten salt bath 521, and then contacting at least the first major surface 503 with the molten salt solution 523 can comprise immersing the glass-based substrate 511 in the molten salt solution 523, for example with both the first major surface 503 and the second major surface 505 in contact with the molten salt solution 523, although only a portion of the foldable substrate may contact the molten salt solution in other aspects. Chemically strengthening the glass-based substrate 511 by ion exchange can occur when a first cation within a depth of a surface of the glass-based substrate 511 is exchanged with a second cation within a molten salt solution 523 that has a larger radius than the first cation. For example, a lithium cation within the depth of the surface of the glass-based substrate 511 can be exchanged with a sodium cation or potassium cation within the molten salt solution 523. Similarly, a sodium cation within the depth of the surface of the glass-based substrate 511 can be exchanged with a potassium cation within the molten salt solution 523 to develop compressive stress within the glass-based substrate 511. Consequently, the surface of the glass-based substrate 511 is placed in compression and thereby chemically strengthened by the ion exchange process since the lithium cation has a smaller radius than the radius of the exchanged sodium cation or potassium cation within the molten salt solution 523.

In further aspects, the first temperature can be 330 °C or more, 340 °C or more, 350 °C or more, 360 °C or more, 370 °C or more, 380 °C or more, 390 °C or more, 400 °C or more, 410 °C or more, 420 °C or more, 430 °C or more, 440 °C or more, 450 °C or more, 550 °C or less, 530 °C or less, 500 °C or less, 480 °C or less, 470 °C or less, 460 °C or less, 450 °C or less, 440 °C or less, or 430 °C or less. In further aspects, the first temperature can be from greater than or equal to 330 °C to less than or equal to 550 °C, from greater than or equal to 340 °C to less than or equal to 530 °C, from greater than or equal to 350 °C to less than or equal to 500 °C, from greater than or equal to 360 °C to less than or equal to 500 °C, from greater than or equal to 370 °C to less than or equal to 490 °C, from greater than or equal to 380 °C to less than or equal to 480 °C, from greater than or equal to 390 °C to less than or equal to 470 °C, from greater than or equal to 390 °C to less than or equal to 460 °C, from greater than or equal to 400 °C to less than or equal to 450 °C, from greater than or equal to 400 °C to less than or equal to 440 °C, from greater than or equal to 410 °C to less than or equal to 440 °C, or any range or subrange therebetween.

As used herein, the first period of time with reference to the chemical strengthening in step 403 (and similarly for the second period of time discussed below with reference to the second chemical strengthening in step 407) refers to a total period of time that the glass-based substrate 511 is in contact with (e.g., immersed in) the corresponding molten salt solution, which includes the period of time (if any) during and after the addition of the phosphate salt in step 405 (and step 409). For example, if a glass-based substrate is immersed in a molten salt solution for a total of 4 hours in a first chemical strengthening treatment where a phosphate salt is added 3 hours into this treatment (and, therefore, extending for 1 hour thereafter), then the first period of time is 4 hours. In further aspects, the first period of time can be 10 minutes or more, 15 minutes or more, 30 minutes or more, 45 minutes or more, 1 hour or more, 1.5 hours or more, 2 hours or more, 2.5 hours or more, 3 hours or more, 3.5 hour or more, 4 hours or more, 5 hours or more, 8 hours or less, 7 hours or less, 6 hours or less, 5 hours or less, 4.5 hours or less, 4 hours or less, 3.5 hour or less, 3 hours or less, 2 hour or less, or 1 hour or less. In further aspects, the first period of time can be from greater than or equal to 10 minutes to less than or equal to 8 hours, from greater than or equal to 15 minutes to less than or equal to 7 hours, from greater than or equal to 30 minutes to less than or equal to 6 hours, from greater than or equal to 45 minutes to less than or equal to 5 hours, from greater than or equal to 1 hour to less than or equal to 4.5 hours, from greater than or equal to 1.5 hours to less than or equal to 4 hours, from greater than or equal to 2 hours to less than or equal to 3.5 hours, from greater than or equal to 2.5 hours to less than or equal to 3 hours, or any range or subrange therebetween. In preferred aspects, the first period of time can be from greater than or equal to 10 minutes to less than or equal to 8 hours, from greater than or equal to 2 hours to less than or equal to 6 hours, from greater than or equal to 3 hours to less than or equal to 4.5 hours, or any range or subrange therebetween.

In aspects, the molten salt solution 523 can comprise a molten nitrate salt (e.g., KNO₃, NaNO₃, or combinations thereof), although other sodium salts and/or potassium salts may be used in the ion-exchange medium, such as, for example, sodium or potassium nitrites, phosphates, carbonates, acetates, chlorides, or sulfates. In further aspects, the molten salt solution 523 may include lithium salts, such as LiNO₃. It is to be understood that a lithium salt in the molten salt solution 523 can be the result of previously using the molten salt solution to chemically strengthening another glass-based substrate containing lithium (e.g., a lithium aluminosilicate glass), although lithium salts can be added in an initial composition of a molten salt composition in other aspects. In further aspects, the molten salt solution may include any combination of NaNO₃ and KNO₃, for example, in the amounts described below, such as a molten salt solution containing 80 wt % NaNO₃ and 20 wt % KNO₃, 70 wt % NaNO₃ and 30 wt % KNO₃, 60 wt % NaNO₃ and 40 wt % KNO₃, 50 wt % NaNO₃ and 50 wt % KNO₃, 40 wt % NaNO₃ and 60 wt % KNO₃, or any range or subrange therebetween. In further aspects, a wt % ratio of potassium to sodium in the molten salt solution can be 66:33 or more, 75:25 or more, 80:20 or more, 85:15 or more, 90:10 or more, 95:5 or more, 99:1 or less, 95:5 or less, 90:10 or less, 85:15 or less, 80:20 or less, or 75:25 or less, for example, from 66:33 to 99:1, from 75:25 to 95:5, from 80:20 to 90:10, from 80:20 to 85:15, or any range or subrange therebetween. In further aspects, an amount of a sodium salt (e.g., sodium nitrate), based on 100 wt % of the molten salt solution, can be 0 wt % or more, 10 wt % or more, 20 wt % or more, 25 wt % or more, 33 wt % or more, 40 wt % or more, 45 wt % or more, 50 wt % or more, 55 wt % or more, 60 wt % or more, 66 wt % or more, 70 wt % or more, 75 wt % or more, 80 wt % or more, 85 wt % or more, 90 wt % or more, 100 wt % or less, 95 wt % or less, 90 wt % or less, 85 wt % or less, 80 wt % or less, 75 wt % or less, 70 wt % or less, 66 wt % or less, 60 wt % or less, 55 wt % or less, 50 wt % or less, 45 wt % or less, 40 wt % or less, 33 wt % or less, 25 wt % or less, 20 wt % or less, or 10 wt % or less. In further aspects, an amount of the sodium salt (e.g., sodium nitrate), based on 100 wt % of the molten salt solution, can be from greater than or equal to 0 wt % to less than or equal to 100 wt %, from greater than or equal to 10 wt % to less than or equal to 95 wt %, from greater than or equal to 20 wt % to less than or equal to 90 wt %, from greater than or equal to 25 wt % to less than or equal to 85 wt %, from greater than or equal to 33 wt % to less than or equal to 80 wt %, from greater than or equal to 40 wt % to less than or equal to 75 wt %, from greater than or equal to 45 wt % to less than or equal to 70 wt %, from greater than or equal to 50 wt % to less than or equal to 66 wt %, from greater than or equal to 55 wt % to less than or equal to 60 wt %, or any range or subrange therebetween. In preferred aspects, an amount of a sodium salt (e.g., sodium nitrate) in the molten salt solution can be from greater than or equal to 0 wt % to less than or equal to 100 wt %, from greater than or equal to 20 wt % to less than or equal to 80 wt %, from greater than or equal to 33 wt % to less than or equal to 66 wt %, or any range or subrange therebetween. In further aspects, an amount of the potassium salt (e.g., potassium nitrate), based on 100 wt % of the molten salt solution, can be 0 wt % or more, 5 wt % or more, 8 wt % or more, 10 wt % or more, 10 wt % or more, 13 wt % or more, 15 wt % or more, 18 wt % or more, 20 wt % or more, 25 wt % or more, 30 wt % or more, 33 wt % or more, 40 wt % or more, 45 wt % or more, 50 wt % or more, 55 wt % or more, 60 wt % or more, 66 wt % or more, 70 wt % or more, 75 wt % or more, 80 wt % or more, 85 wt % or more, 90 wt % or more, 100 wt % or less, 95 wt % or less, 90 wt % or less, 85 wt % or less, 75 wt % or less, 70 wt % or less, 66 wt % or less, 60 wt % or less, 55 wt % or less, 50 wt % or less, 45 wt % or less, 40 wt % or less, 33 wt % or less, 30 wt % or less, 25 wt % or less, 20 wt % or less, 18 wt % or less, 15 wt % or less, 13 wt % or less, 10 wt % or less, 8 wt % or less, or 5 wt % or less. In further aspects, an amount of potassium salt (e.g., potassium nitrate), based on 100 wt % of the molten salt solution, can be from greater than or equal to 0 wt % to less than or equal to 100 wt %, from greater than or equal to 5 wt % to less than or equal to 95 wt %, from greater than or equal to 8 wt % to less than or equal to 90 wt %, from greater than or equal to 10 wt % to less than or equal to 85 wt %, from greater than or equal to 13 wt % to less than or equal to 80 wt %, from greater than or equal to 15 wt % to less than or equal to 75 wt %, from greater than or equal to 18 wt % to less than or equal to 70 wt %, from greater than or equal to 20 wt % to less than or equal to 66 wt %, from greater than or equal to 25 wt % to less than or equal to 60 wt %, from greater than or equal to 30 wt % to less than or equal to 55 wt %, from greater than or equal to 33 wt % to less than or equal to 55 wt %, from greater than or equal to 40 wt % to less than or equal to 50 wt %, or any range or subrange therebetween. In preferred aspects, an amount of a potassium salt (e.g., potassium nitrate) in the molten salt solution can be from greater than or equal to 0 wt % to less than or equal to 100 wt %, from greater than or equal to 20 wt % to less than or equal to 80 wt %, from greater than or equal to 33 wt % to less than or equal to 66 wt %, or any range or subrange therebetween. Also, it is to be understood that a balance of the molten salt solution (excluding any components added by superaddition) can be a potassium salt (e.g., potassium nitrate) when an amount of a sodium salt (e.g., sodium nitrate) is specified or vice versa. In further aspects, the molten salt solution can optionally comprise (by superaddition) silicic acid, for example, from greater than 0 wt % to 2 wt %, from greater than 0 wt % to 1 wt %, from 0.2 wt % to 1.0 wt %, from 0.5 wt % to 0.7 wt %, or any range or subrange therebetween.

In aspects, after step 403, methods can proceed to step 405 comprising adding a phosphate salt 603 to the molten salt solution 523 (as indicated by arrow 601) during the contacting the glass-based substrate 511 (e.g., first major surface 503 and/or second major surface 505) with the molten salt solution 523, as shown in FIG. 6. In further aspects, the phosphate salt can comprise trisodium phosphate (Na₃PO₄), tripotassium phosphate (K₃PO₄), disodium phosphate (Na₂HPO₄), dipotassium phosphate (K₂HPO₄), sodium tripolyphosphate (Na₅P₃O₁₀), potassium tripolyphosphate (Na₅P₃O₁₀), sodium pyrophosphate (Na₄P₂O₇), potassium pyrophosphate (K₄P₂O₇), trisodium pyrophosphate (Na₃HP₂O₇), tripotassium pyrophosphate (K₃HP₂O₇), disodium pyrophosphate (Na₂H₂ P₂O₇), dipotassium pyrophosphate (K₂H₂P₂O₇), or combinations thereof. Without wishing to be bound by theory, it is believed that the phosphate salt can preferentially bind to lithium cations in the molten salt solution (e.g., that can be present due to the current and/or previous chemical strengthening treatments using the molten salt solution)—and potentially precipitate the lithium out of the molten salt solution—, which can improve the stress profile and/or mechanical properties of the resulting glass-based article. For example, when the phosphate salt is trisodium phosphate (Na₃PO₄, TSP) can react with lithium in the molten salt solution to form lithium disodium phosphate (LiNa₂PO₄) that can precipitate out of the molten salt solution, reducing the concentration of lithium in solution in the molten salt solution. Consequently, removing (or at least decreasing an activity) of lithium in the molten salt solution can increase the effect of the chemical strengthening treatment on the resulting stress profile and/or mechanical properties since the competition between lithium and larger alkali metals is reduced. As demonstrated by the Examples herein (see Table 1 and FIG. 10), adding the phosphate salt can increase a maximum compressive stress (e.g., at the first major surface) and/or compressive stress at a predetermined depth (e.g., 20 μm, 40 μm) from the first major surface. Also, as demonstrated by the Examples herein (see FIG. 11), the addition of the phosphate salt can increase a retained strength (i.e., failure strength) of the resulting glass-based article for flaws having an intermediate depth (e.g., from 20 μm to 60 μm). Additionally, as shown in FIG. 14, the addition of the phosphate salt can reduce an extent of flaws (i.e., effective flaw depth) formed in the Slapper Test.

In further aspects, an amount of the phosphate salt added to the molten salt solution, based on 100 wt % of the molten salt solution before adding the phosphate salt, can be 0.01 wt % or more, 0.05 wt % or more, 0.10 wt % or more, 0.15 wt % or more, 0.20 wt % or more, 0.25 wt % or more, 0.30 wt % or more, 0.35 wt % or more, 0.40 wt % or more, 0.50 wt % or more, 0.6 wt % or more, 0.8 wt % or more, 1.0 wt % or more, 1.2 wt % or more, 1.4 wt % or more, 1.5 wt % or more, 1.6 wt % or more, 1.8 wt % or more, 2.0 wt % or less, 1.8 wt % or less, 1.5 wt % or less, 1.2 wt % or less, 1.0 wt % or less, 0.8 wt % or less, 0.6 wt % or less, 0.5 wt % or less, 0.4 wt % or less, 0.3 wt % or less, 0.25 wt % or less, 0.20 wt % or less, 0.15 wt % or less, or 0.10 wt % or less. In further aspects, an amount of the phosphate salt added to the molten salt solution, based on 100 wt % of the molten salt solution before adding the phosphate salt, can be from greater than or equal to 0.01 wt % to less than or equal to 2.0 wt %, from greater than or equal to 0.05 wt % to less than or equal to 1.8 wt %, from greater than or equal to 0.10 wt % to less than or equal to 1.5 wt %, from greater than or equal to 0.15 wt % to less than or equal to 1.2 wt %, from greater than or equal to 0.20 wt % to less than or equal to 1.0 wt %, from greater than or equal to 0.25 wt % to less than or equal to 0.8 wt %, from greater than or equal to 0.30 wt % to less than or equal to 0.6 wt %, from greater than or equal to 0.35 wt % to less than or equal to 0.5 wt %, from greater than or equal to 0.40 wt % to less than or equal to 0.45 wt %, or any range or subrange therebetween. In further aspects, an amount of the phosphate salt added to the molten salt solution, based on 100 wt % of the molten salt solution before adding the phosphate salt, can be less than or equal to 0.5 wt %, for example, from greater than or equal to 0.01 wt % to less than or equal to 0.50 wt %, from greater than or equal to 0.05 wt % to less than or equal to 0.45 wt %, from greater than or equal tom 0.10 wt % to less than or equal to 0.40 wt %, from greater than or equal to 0.15 wt % to less than or equal to 0.35 wt %, from greater than or equal to 0.20 wt % to less than or equal to 0.30 wt %, from greater than or equal to 0.20 wt % to less than or equal to 0.25 wt %, or any range or subrange therebetween. In preferred aspects, In further aspects, an amount of the phosphate salt added to the molten salt solution, based on 100 wt % of the molten salt solution before adding the phosphate salt, can be from greater than or equal to 0.01 wt % to less than or equal to 2.0 wt %, from greater than or equal to 0.05 wt % to less than or equal to 0.5 wt %, from greater than or equal to 0.10 wt % to less than or equal to 0.3 wt %, or any range or subrange therebetween. Adding a phosphate salt (e.g., less than or equal to 2.0 wt %, from 0.05 wt % to 0.5 wt %) to the molten salt solution during the chemical strengthening process can increase the properties of the resulting glass-based article without leaving residues, without impairing the optical properties, and/or without impairing the cosmetic appearance of the resulting glass-based article. Further, due to the high lithium content glass-based substrates being chemically strengthened, the phosphate released from the phosphate salt can bind with lithium already released into the molten salt solution rather than aggregating at the surface of glass-based substrate where it could cause cosmetic defects (e.g., “spotting”). Indeed, adding the phosphate salt partway through the chemical strengthening can ensure that there is sufficient lithium in the molten salt solution for this binding to occur.

In further aspects, the phosphate salt 603 can be added to the molten salt solution 523 (as indicated by arrow 601) a predetermined period of time after the contacting the glass-based substrate 511 with the molten salt solution 523 started (i.e., how long after the start of the first period of time in step 403 before step 405 begins). In even further aspects, the predetermined period of time after the contacting the glass-based substrate 511 with the molten salt solution 523 started, for example when the first period of time is 2 hours or more, can be 45 minutes or more, 60 minutes or more, 75 minutes or more, 90 minutes or more, 105 minutes or more, 105 minutes or less, 90 minutes or less, 75 minutes or less, 60 minutes or less, or 45 minutes or less. In even further aspects, the predetermined period of time after the contacting the glass-based substrate 511 with the molten salt solution 523 started, for example when the first period of time is 2 hours or more, can be from greater than or equal to 45 minutes to less than or equal to 105 minutes, from greater than or equal to 60 minutes to less than or equal to 90 minutes, from greater than or equal to 75 minutes to less than or equal to 90 minutes, or any range or subrange therebetween. In even further aspects, the predetermined period of time after the contacting the glass-based substrate 511 with the molten salt solution 523 started, as a percentage of the first period of time (i.e., corresponding to the total duration of the contacting the glass-based substrate 511 with the molten salt solution 523), can be 25% or more, 33% or more, 40% or more, 45% or more, 50% or more, 55% or more, 60% or more, 66% or more, 70% or more, 75% or less, 70% or less, 66% or less, 60% or less, 55% or less, 50% or less, 45% or less, 40% or less, or 33% or less. In even further aspects, the predetermined period of time after the contacting the glass-based substrate 511 with the molten salt solution 523 started, as a percentage of the first period of time (i.e., corresponding to the total duration of the contacting the glass-based substrate 511 with the molten salt solution 523), can be from greater than or equal to 25% to less than or equal to 75%, from greater than or equal to 33% to less than or equal to 70%, from greater than or equal to 40% to less than or equal to 66%, from greater than or equal to 45% to less than or equal to 60%, from greater than or equal to 50% to less than or equal to 55%, or any range or subrange therebetween.

In further aspects, the phosphate salt 603 can be added to the molten salt solution 523 (as indicated by arrow 601) a predetermined period of time before an end of the contacting the glass-based substrate 511 with the molten salt solution 523 started (i.e., how long before the end of the first period of time in step 403 before step 405 begins). In even further aspects, the predetermined period of time before the end of the contacting the glass-based substrate 511 with the molten salt solution 523, for example when the first period of time is 2 hours or more, can be 45 minutes or more, 60 minutes or more, 75 minutes or more, 90 minutes or more, 105 minutes or more, 105 minutes or less, 90 minutes or less, 75 minutes or less, 60 minutes or less, or 45 minutes or less. In even further aspects, the predetermined period of time before the end of the contacting the glass-based substrate 511 with the molten salt solution 523 started, for example when the first period of time is 2 hours or more, can be from greater than or equal to 45 minutes to less than or equal to 105 minutes, from greater than or equal to 60 minutes to less than or equal to 90 minutes, from greater than or equal to 75 minutes to less than or equal to 90 minutes, or any range or subrange therebetween. In even further aspects, the predetermined period of time before the end of the contacting the glass-based substrate 511 with the molten salt solution 523, as a percentage of the first period of time (i.e., corresponding to the total duration of the contacting the glass-based substrate 511 with the molten salt solution 523), can be 25% or more, 30% or more, 33% or more, 40% or more, 45% or more, 50% or more, 55% or more, 60% or more, 66% or more, 70% or more, 75% or less, 70% or less, 66% or less, 60% or less, 55% or less, 50% or less, 45% or less, 40% or less, or 33% or less. In even further aspects, the predetermined period of time after the contacting the glass-based substrate 511 with the molten salt solution 523 started, as a percentage of the first period of time (i.e., corresponding to the total duration of the contacting the glass-based substrate 511 with the molten salt solution 523), can be from greater than or equal to 25% to less than or equal to 75%, from greater than or equal to 30% to less than or equal to 70%, from greater than or equal to 33% to less than or equal to 66%, from greater than or equal to 40% to less than or equal to 60%, from greater than or equal to 45% to less than or equal to 55%, from greater than or equal to 45% to less than or equal to 50%, or any range or subrange therebetween.

Without wishing to be bound by theory, it is believed that the phosphate salt can take a significant amount of time (e.g., greater than or equal to an hour, from greater than or equal to 2 hours to less than or equal to 4 hours) to achieve the full extent of the lithium concentration reduction. Consequently, adding the phosphate salt partway (e.g., at least 45 minutes after the start of the chemical strengthening process with that molten salt solution, at least 45 minutes before the end of the chemical strengthening process with that molten salt solution, from 25% to 75% of the way through the chemical strengthening process with that molten salt solution), can act to reduce (e.g., limit, reduce) the lithium concentration in the molten salt solution throughout a significant portion of the remainder of the chemical strengthening process (if not the entire remainder of the chemical strengthening process). As a result, the composition of the molten salt bath can shift from before the phosphate salt is added versus after the phosphate salt is added. In some situations, this shift in composition (through the removal and/or decreased activity of lithium) can have an effect similar to a multi-step chemical strengthening process even though a single molten salt solution is used. Additionally or alternatively, the addition of the phosphate salt can limit a maximum concentration of lithium in the molten salt solution during the chemical strengthening process. Consequently, higher compressive stresses and/or stress profiles can be achieved as the effect of reverse ion-exchange from the lithium concentration in the molten salt solution is reduced. In particular, when the composition of the glass-based substrate being chemically strengthened contains a larger amount of lithium (e.g., from greater than or equal to 20 mol % to less than or equal to 45 mol %), an increase in lithium concentration in the molten salt solution can be significant (e.g., greater than or equal to 0.1 wt %) during the chemical strengthening process. Adding the phosphate salt in this situation, can mitigate the extent of this increase in lithium. In particular, the high lithium glasses discussed herein can release a significant amount of lithium into the molten salt solution that could otherwise impair the compressive stress achieved-especially near the surface of the glass-based substrate. Additionally, adding the phosphate salt during the chemical strengthening treatment can increase a throughput and/or a longevity of the molten salt solution. As discussed above, the phosphate salt can take a significant amount of time to have full effect; so, adding the phosphate salt during the chemical strengthening process can reduce an amount of time after the end of the chemical strengthening process before the phosphate salt has full effect, which allows for a subsequent chemical strengthening processing using the molten salt solution to begin sooner than if the phosphate salt was added after the chemical strengthening process was complete.

In aspects, the addition of the phosphate salt during the chemical strengthening of the glass-based substrate (to form the glass-based article) can reduce the extent that a lithium concentration increases during the remainder of the chemical strengthening process (e.g., after the phosphate salt is added). In further aspects, a concentration of lithium in solution in the molten salt solution after an end of the contacting, as a percentage of the concentration of lithium in solution in the molten salt solution before the contacting (i.e., Li(after)/Li(before)×100%), can be 133% or less, 125% or less, 120% or less, 115% or less, 110% or less, 105% or less, 100% or less, 95% or less, 90% or less, 85% or less, 80% or less, 75% or less, 70% or less, or 66% or less. In further aspects, a concentration of lithium in solution in the molten salt solution after an end of the contacting, as a percentage of the concentration of lithium in solution in the molten salt solution before the contacting, form greater than or equal to 50% to less than or equal to 133%, from greater than or equal to 60% to less than or equal to 125%, from greater than or equal to 66% to less than or equal to 120%, from greater than or equal to 70% to less than or equal to 115%, from greater than or equal to 75% to less than or equal to 110%, from greater than or equal to 80% to less than or equal to 105%, from greater than or equal to 85% to less than or equal to 100%, from greater than or equal to 90% to less than or equal to 95%, or any range or subrange therebetween. In further aspects, a concentration of lithium in the molten salt solution can decrease from the beginning of the chemical strengthening process to the end of the chemical strengthening process with a corresponding molten salt solution (i.e., Li(after)<Li(before); Li(after)/Li(before)×100%<100%).

In aspects, the addition of the phosphate salt during the chemical strengthening of the glass-based substrate (to form the glass-based article) can reduce the extent that a lithium concentration increases by the time that the phosphate salt takes full effect (e.g., 4 hours after the end of the chemical strengthening process). In further aspects, a concentration of lithium in solution in the molten salt solution 4 hours after an end of the contacting, as a percentage of the concentration of lithium in solution in the molten salt solution before the contacting (i.e., Li(after+4 hours)/Li(before)×100%), can be 133% or less, 125% or less, 120% or less, 115% or less, 110% or less, 105% or less, 100% or less, 95% or less, 90% or less, 85% or less, 80% or less, 75% or less, 70% or less, or 66% or less. In further aspects, a concentration of lithium in solution in the molten salt solution 4 hours after an end of the contacting, as a percentage of the concentration of lithium in solution in the molten salt solution before the contacting, can be from greater than or equal to 50% to less than or equal to 133%, from greater than or equal to 60% to less than or equal to 125%, from greater than or equal to 66% to less than or equal to 120%, from greater than or equal to 70% to less than or equal to 115%, from greater than or equal to 75% to less than or equal to 110%, from greater than or equal to 80% to less than or equal to 105%, from greater than or equal to 85% to less than or equal to 100%, from greater than or equal to 90% to less than or equal to 95%, or any range or subrange therebetween. In further aspects, a concentration of lithium in solution in the molten salt solution can decrease from before the chemical strengthening process begins to 4 hours after an end of the chemical strengthening process with the corresponding molten salt solution, as a percentage of the concentration of lithium in solution in the molten salt solution before the contacting (i.e., Li(after+4 hours)<Li(before); (i.e., Li(after+4 hours)/Li(before)×100%<100%). In even further aspects, a concentration of lithium in solution in the molten salt solution 4 hours after an end of the contacting, as a percentage of the concentration of lithium in solution in the molten salt solution before the contacting, can be from greater than or equal to 50% to less than 100%, from greater than or equal to 60% to less than or equal to 95%, from greater than or equal to 66% to less than or equal to 90%, from greater than or equal to 70% to less than or equal to 85%, from greater than or equal to 75% to less than or equal to 80%, or any range or subrange therebetween.

In aspects, the addition of the phosphate salt during the chemical strengthening of the glass-based substrate (to form the glass-based article) can have the effect of reducing the lithium concentration between the end of the chemical strengthening process (with that molten salt solution) and the time that the phosphate salt takes full effect (e.g., 4 hours after the end of the chemical strengthening process). In further aspects, a concentration of lithium in solution in the molten salt solution can decrease from an end of the contacting to 4 hours after the end of the contacting. In further aspects, a concentration of lithium in solution in the molten salt solution 4 hours after the end of the contacting, as a percentage of the concentration of lithium in solution in the molten salt solution at the end of the contacting (i.e., Li(after+4 hours)/Li(after)×100%), can be less than 100%, less than or equal to 90%, less than or equal to 80%, less than or equal to 75%, less than or equal to 70%, less than or equal to 66%, less than or equal to 60%, less than or equal to 55%, or less than or equal to 50%. In further aspects, a concentration of lithium in solution in the molten salt solution 4 hours after the end of the contacting, as a percentage of the concentration of lithium in solution in the molten salt solution at the end of the contacting, can be from greater than or equal to 33% to less than 100%, from greater than or equal to 40% to less than or equal to 90%, from greater than or equal to 50% to less than or equal to 80%, from greater than or equal to 55% to less than or equal to 75%, from greater than or equal to 60% to less than or equal to 66%, or any range or subrange therebetween. In exemplary aspects, a concentration of lithium in solution in the molten salt solution 4 hours after the end of the contacting, as a percentage of the concentration of lithium in solution in the molten salt solution at the end of the contacting, can be from greater than or equal to 33% to less than 100%, from greater than or equal to 50% to less than or equal to 80%, or from greater than or equal to 55% to less than or equal to 66%.

In aspects, the addition of the phosphate salt can achieve a lithium concentration in the molten salt solution (based on 100 wt % of the molten salt solution)—at the end of the chemical strengthening process and/or 4 hours after the end of the chemical strengthening process with the corresponding molten salt solution—below a predetermined threshold, for example, less than or equal to 0.30 wt %, less than or equal to 0.27 wt %, less than or equal to 0.25 wt %, less than or equal to 0.22 wt %, less than or equal to 0.20 wt %, less than or equal to 0.17 wt %, or less than or equal to 0.15 wt %. In aspects, the addition of the phosphate salt can achieve a lithium concentration in the molten salt solution (based on 100 wt % of the molten salt solution)—at the end of the chemical strengthening process and/or 4 hours after the end of the chemical strengthening process with the corresponding molten salt solution—can be from greater than or equal to 0.10 wt % to less than or equal to 0.30 wt %, from greater than or equal to 0.12 wt % to less than or equal to 0.27 wt %, from greater than or equal to 0.15 wt % to less than or equal to 0.25 wt %, from greater than or equal to 0.17 wt % to less than or equal to 0.25 wt %, from greater than or equal to 0.20 wt % to less than or equal to 0.22 wt %, or any range or subrange therebetween.

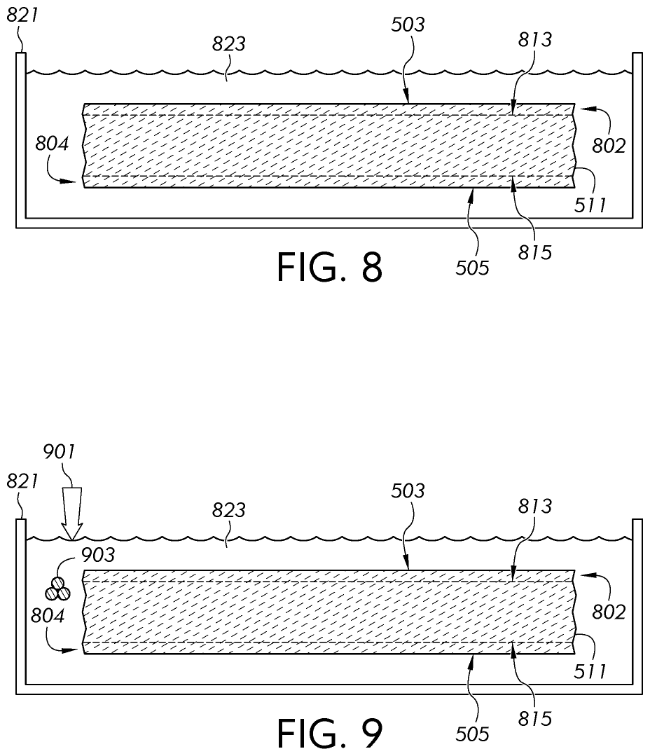

After step 403 or 405, in aspects, methods can proceed to step 407 comprising further chemically strengthening the glass-based substrate 511 by contacting at least a portion of the glass-based substrate 511 with a second molten salt solution 823 maintained at a second temperature for a second period of time, as shown in FIG. 8. In aspects, as shown, step 407 can comprise immersing the glass-based substrate 511 in the second molten salt solution 823 containing in a second bath 821. As a result of step 403 and/or 405, the glass-based substrate already has initial compressive stress regions 802 and/or 804 extending to corresponding initial depths of compression (indicated by dashed lines 813 and/or 815, respectively). In aspects, the second temperature can be within one or more of the ranges discussed above for the first temperature. In aspects, the composition of the second molten salt solution 823 can be within one or more of the corresponding ranges for the first molten salt solution. In aspects, the second molten salt solution can contain a greater concentration of potassium salt than the corresponding amount in the first molten salt solution (if any). In further aspects, the second molten salt solution can comprise greater than or equal to 50 wt % of the potassium salt, for example, greater than or equal to 66 wt % of the potassium salt, or greater than or equal to 75 wt % of the potassium salt, including 100 wt % of the potassium salt. In aspects, the second period of time can be within one or more of the ranges discussed above for the first period of time. In aspects, the second period of time can be less than the first period of time. In further aspects, the second period of time can be less than or equal to 2 hours, less than or equal to 1.5 hours, less than or equal to 1.0 hour, less than or equal to 45 minutes, less than or equal to 30 minutes, less than or equal to 20 minutes, less than or equal to 10 minutes, greater than or equal to 1 minute, greater than or equal to 3 minutes, greater than or equal to 5 minutes, greater than or equal to 7 minutes, greater than or equal to 10 minutes, greater than or equal to 15 minutes, greater than or equal to 20 minutes, greater than or equal to 25 minutes, greater than or equal to 30 minutes, greater than or equal to 40 minutes, greater than or equal to 50 minutes, or greater than or equal to 60 minutes. In further aspects, the second period of time can be from greater than or equal to 1 minute to less than or equal to 2 hours, from greater than or equal to 3 minutes to less than or equal to 1.5 hours, from greater than or equal to 5 minutes to less than or equal to 1.0 hour, from greater than or equal to 7 minutes to less than or equal to 45 minutes, from greater than or equal to 10 minutes to less than or equal to 30 minutes, from greater than or equal to 15 minutes to less than or equal to 20 minutes, or any range or subrange therebetween.

In aspects, after step 407, methods can proceed to step 409 comprising adding a phosphate salt 903 to the second molten salt solution 823 (as indicated by arrow 901) during the contacting the glass-based substrate 511 (e.g., first major surface 503 and/or second major surface 505) with the second molten salt solution 823, as shown in FIG. 8. In further aspects, the phosphate salt can one or more of the materials discussed above for the phosphate salt in step 405. In further aspects, the amount of the phosphate salt added to the second molten salt solution can be within one or more of the ranges discussed above for the amount of the phosphate salt added to the first molten salt solution in step 405. In further aspects, the phosphate salt 903 can be added to the second molten salt solution 823 (as indicated by arrow 901) a predetermined period of time after the contacting the glass-based substrate 511 with the second molten salt solution 823 started, which can be within one or more of the corresponding ranges discussed above for the time after the start of step 403 that the phosphate salt is added in step 405—in terms of absolute time (e.g., from greater than or equal to 45 minutes to less than or equal to 105 minutes) and/or in terms of percentage of the contacting the glass-based substrate with the corresponding molten salt solution (e.g., from greater than or equal to 25% to less than or equal to 75%). In further aspects, the phosphate salt 803 can be added to the second molten salt solution 823 (as indicated by arrow 901) a predetermined period of time before the end of the contacting the glass-based substrate 511 with the second molten salt solution 823, which can be within one or more of the corresponding ranges discussed above for the time before the end of the contacting in step 403 that the phosphate salt is added in step 405—in terms of absolute time (e.g., from greater than or equal to 45 minutes to less than or equal to 105 minutes) and/or in terms of percentage of the contacting the glass-based substrate with the corresponding molten salt solution (e.g., from greater than or equal to 25% to less than or equal to 75%).

After step 405, 407, or 409, methods can proceed to step 411. In aspects, step 411 can comprise assembling a display device (e.g., the consumer electronic device in FIGS. 1-2 and/or 3) comprising the glass-based article, for example, as part of the housing and/or the cover substrate 112 in the consumer electronic device 100 shown in FIGS. 1-2 and/or a corresponding portion in the consumer electronic device 301 shown in FIG. 3. Additionally or alternatively, step 411 can comprise further treating the glass-based article 701 can comprise rinsing the glass-based article 701 (e.g., in deionized water or an alkaline detergent solution) and/or etching the glass-based article 701 to remove less than 5 μm from each surface, which can increase a mechanical strength of the glass-based article 701. An exemplary aspect of an alkaline detergent solution includes SemiClean KG (Yokohama Oils & Fats Industry Co.). Alternatively or additionally, methods can be complete upon reaching the step 411.

In aspects, methods of chemically strengthening a glass-based substrate to make glass-based article in accordance with aspects of the disclosure can proceed along steps 401, 403, 405, 407, 409, 411, and 411 of the flow chart in FIG. 4 sequentially, as discussed above. In aspects, arrow 402 can be followed from step 403 to step 407, for example, when a phosphate salt is not added during a first chemical strengthening treatment (in step 405) but is added during a second chemical strengthening treatment (in step 409). In aspects, arrow 404 can be followed from step 405 to step 413, for example, when methods are complete after adding a phosphate salt during the chemical strengthening treatment in steps 403 and 405. In aspects, arrow 406 can be followed from step 405 to step 411, for example, when the glass-based article is to be incorporated into a consumer electronic device after adding a phosphate salt during the chemical strengthening treatment in steps 403 and 405. In aspects, arrow 408 can be followed from step 407 to step 413, for example, if methods are complete at the end of step 407 (e.g., a second chemical strengthening treatment in step 407). In aspects, arrow 410 can be followed from step 407 to step 411, for example, when the glass-based article is to be incorporated into a consumer electronic device after adding the second chemical strengthening treatment in step 407. Any of the above options may be combined to make a color converter sheet in accordance with aspects of the disclosure.

In aspects, methods in accordance with aspects of the disclosure may consist of the steps discussed above. For example, the foldable substrate may not be further treated between one or more (or even all of) the steps described above with reference to the flow chart in FIG. 4. Throughout the disclosure, the phrase “not further treated” or “not be further treated” excludes treatments to the first major surface other than the stated contacting with a solution and rinsing with water (e.g., purified, filtered, deionized, distilled). Exemplary aspects of treatments that can be excluded under “not further treated” or “not be further treated” include treatment with additional acidic solutions, basic solutions, fluorine-containing solutions, detergents, and mechanical polishing of the foldable substrate.

### EXAMPLES

Various aspects will be further clarified by the following examples. Examples herein use glass substrates having Composition C1 comprising in mol %: 56.5 SiO₂, 1.5 Al₂O₃, 39.3 Li₂O, 0.6 CaO, 1.6 ZrO₂, 0.4 P₂O₅, and 0.1 SnO₂. Unless otherwise indicated, the thickness of the glass substrates was 0.5 mm.

For the Examples presented in Table 1, the molten salt solution comprised 40 wt % sodium nitrate (NaNO₃) and 60 wt % potassium nitrate (KNO₃) with 1 wt % silicic acid and 0.18 wt % lithium nitrate (LiNO₃)—other than Example 1—added by superaddition, and the glass substrates were immersed in the molten salt solution for 3 hours and 10 minutes while the molten salat solution is maintained at 530 °C. Here, the lithium nitrate was added to simulate a previously used molten salt bath, where the previously chemically strengthened glasses would have added the lithium salt as a result of the ion-exchange process for those glasses. Tri-sodium phosphate (TSP, Na₃PO₄) was added at different times in the chemical strengthening process (including during, before, after, or not all), as indicated in Table 1. In Table 1, the “initial TSP” was added before the chemical strengthening process. Here, the “initial TSP” was part of the initial composition of the materials heated to form the molten salt solution. In contrast, the “TSP added” was added during the chemical strengthening process.

TABLE 1
Conditions and Properties of Examples 1-4 and Comparative Example AA

| | Initial | Initial | TSP after | TSP | | | | | |
|---|---|---|---|---|---|---|---|---|---|
| | LiNO₃ | TSP | Start | Added | CS | CT | DOC | CT/TA | TA*CT |
| Example | (wt %) | (wt %) | (min) | (wt %) | (MPa) | (MPa) | (μm) | (mm⁻¹) | (MPa² mm) |
| AA | 0.18 | 0.24 | n/a | n/a (0) | 300 | 190 | 111 | 5.85 | 6280 |
| 1 | 0.26 | 0.12 | 95 | 0.2 | 360 | 170 | 112 | 5.25 | 5350 |
| 2 | 0.18 | 0.24 | 60 | 0.2 | 410 | 190 | 114 | 5.1 | 6810 |
| 3 | 0.18 | 0.24 | 95 | 0.2 | 400 | 180 | 114 | 5.15 | 6400 |
| 4 | 0.18 | 0.24 | 95 | 0.1 | 360 | 190 | 113 | 5.65 | 6360 |

As shown in Table 1, Examples 2-4 and Comparative Example AA differ based on whether (and if so, when) the phosphate salt (TSP) was added. Comparative Example AA did not have any phosphate salt added. Example 4 had 0.1 wt % phosphate salt (TSP) added 95 minutes after the start (and 95 minutes before the end) of the chemical strengthening. Example 3 was the same as Example 4, but the amount of the phosphate salt (TSP) was 0.2 wt %—instead of 0.1 wt %. Example 2 was the same as Example 3, but the phosphate salt was added 60 minutes after the start (130 minutes before the end) of the chemical strengthening process—instead of 90 minutes. Examples 1-4 all had maximum compressive stress (CS) greater than Comparative Example A even though the central tension (CT) and depth of compression (DOC) values were comparable—the CT values for Examples 1-4 were the same or less or equal to the CT of Comparative Example AA and the DOC for Examples 1-4 were greater than the DOC of Comparative Example AA by less than 3%. “TA” refers to an integral of the tensile region (i.e., integral of tensile stress between the DOCs). Consequently CT/TA is the integral of the tensile region divided by the central tension (CT) while TA*CT is the product of the integral of the tensile region and the central tension (CT). As shown, CT/TA was lower for Examples 1-4 than for Comparative Example AA. Also, CT/TA for Examples 2-4 is greater than or equal to that for Comparative Example AA.

Example 1 is the same as Example 3 but the initial LiNO₃ concentration in Example 1 is higher that of Example 3 and the initial TSP is lower (Example 1 has 50% the initial TSP in Example 3). Due to the increased initial LiNO₃ concentration and lower initial TSP in Example 1, the CS, and CT values are lower for Example 1 compared to Example 3. However, the CS value for Example 1 is still greater than the CS value for Comparative Example AA despite Example 1 having a grater initial lithium concentration and lesser initial TSP than Comparative Example AA. Also, the CT and TA*CT for Example 1 is less than the corresponding values for Comparative Example AA.

FIG. 10 illustrates stress profiles having compressive stress (σ) in MegaPascals (MPa) on the vertical axis 1003 (i.e., y-axis) as a function of depth (d) from the first major surface in millimeters (mm) on the horizontal axis 1001 (i.e., x-axis). Curves 1005 and 1007 correspond to Comparative Examples AA-BB, respectively, without the addition of the phosphate salt during the chemical strengthening process while curves 1009, 1011, 1013, and 1015 correspond to Examples 1-4, respectively, where phosphate salt was added during the chemical strengthening process. The stress profile in curve 1007 for Comparative Example BB corresponds to the that of the glass sample at the end of step BB-1 followed by step BB-2. In step BB-1, the molten salt solution comprised 28 wt % NaNO₃ and 72 wt % KNO₃ with LiNO₃ (0.14 wt % shown in Table 2) added by superaddition; in step BB-2, the molten salt solution comprised 80 wt % NaNO₃ and 20 wt % KNO₃ with LiNO₃ (0.14 wt % shown in Table 2) added by superaddition. As shown in FIG. 10, the maximum compressive stress (at the first major surface) is greater than or equal to 350 MPa for curves 1009, 1011, 1013, and 1015. Also, the compressive stress a depth of 20 μm (0.02 mm) from the first major surface is greater than or equal to 250 MPa for curves 1009, 1011, 1013, and 1015, which is from about 50% to about 70% of the maximum compressive stress (at the first major surface).

TABLE 2
Conditions and Properties of Examples 1-4 and Comparative Example BB

| | Initial | TSP after | TSP | | | | | |
|---|---|---|---|---|---|---|---|---|
| Example | LiNO₃ | Start | Added | CS | CT | DOC | CT/TA | TA*CT |
| BB (step) | (wt %) | (min) | (wt %) | (MPa) | (MPa) | (μm) | (mm⁻¹) | (MPa² mm) |
| BB-1 | 0.14 | n/a | n/a (0) | 380 | 100 | 91 | 3.7 | 2660 |
| BB-2 | 0.18 | n/a | n/a (0) | 320 | 190 | 109 | 5.2 | 6900 |

Further, the impact on the addition of phosphate salt to the molten salt solution during the chemical strengthening process on lithium (e.g. LiNO₃) concentration was assessed. Table 3 presents the lithium concentration and pH of the molten salt solution before, at the end, and/or 4 hours after the end of the chemical strengthening process. In Table 3, the suffix “-A” is added (compared to the Examples 1-4 and Comparative Example AA) since the initial LiNO₃ concentration is different but the other conditions (i.e., NaNO₃ and KNO₃ content, temperature of the molten salt solution, temperature of the chemical strengthening treatment, and when/if a phosphate salt is added) are the same as above. For example, the only difference between the conditions for Example 1 (Table 1) and Example 1-A is that the initial LiNO₃ concentration was 0.211 wt % in Example 1-A instead of 0.26 wt % in Example 1. As used herein, a pH of a solution is measured in accordance with ASTM E70-90 at 25 °C. For the molten salt solution (as reported in Table 3), the pH is determined by dissolving a cooled sample from the molten salt solution in deionized water to form a 5 wt % solution of the sample (from the molten salt solution) based on 100 wt % of the resulting solution. “--” in Table 3 indicates that measurement was not performed.

TABLE 3
Lithium Concentration in Molten Salt Solution Measured by Ion
Chromatography for Examples 1-4 and Comparative Example AA

| | Initial | TSP after | TSP | | End | | LiNO₃ 4 hr |
|---|---|---|---|---|---|---|---|
| | LiNO₃ | Start | Added | End | LiNO₃ | pH 4 hr | after End |
| Example | (wt %) | (min) | (wt %) | pH | (wt %) | after End | (wt %) |
| AA-A | 0.131 | 190 (End) | 0.2 | 10.34 | 0.257 | 10.59 | 0.177 |
| 1-A | 0.211 | 95 | 0.2 | 10.13 | 0.228 | 10.36 | 0.160 |
| 2-A | 0.139 | 60 | 0.2 | 10.49 | 0.179 | — | — |
| 3-A | 0.129 | 95 | 0.2 | 10.48 | 0.190 | — | — |
| 4-A | 0.131 | 95 | 0.1 | 10.30 | 0.222 | 10.39 | 0.179 |

As shown in Table 3, the initial LiNO₃ concentration for Examples 3-A, and 4-A and Comparative Example AA-A was about 0.13 wt %. The lithium concentrations were measured using ion chromatography (IC). For Comparative Example AA, the concentration of LiNO₃ at the end of the chemical strengthening process (before the phosphate salt is added) roughly doubled to about 0.26 wt %. In contrast, adding 0.1 wt % TSP (Example 4-A) decreased the LiNO₃ concentration at the end of the chemical strengthening process to 0.22 wt % (13% decrease compared to Example AA-A. Adding 0.2 wt % TSP (Example 3-A) decreased the LiNO₃ concentration at the end of the chemical strengthening process to 0.19 wt % (37% decrease relative to Comparative Example AA-A; further decrease of 14% relative to Example 3-A). Compared to Example 3-A, the phosphate salt (TSP) for Example 2-A was added 60 minutes after the start of the chemical strengthening process instead of 95 minutes, which means that Example 2-A has more time for the TSP to take effect than Example 3-A before the end of the chemical strengthening treatment. Consequently, the LiNO₃ concentration decreased from 0.19 wt % to 0.18 wt % going from Example 3-A to Example 2-A. Also, Example 1-A has a greater initial LiNO₃ concentration than the other Examples in Table 3 (i.e., 0.21 wt %>0.13 wt %). Still, Example 1-A is able to decrease the LiNO₃ concentration at the end of the chemical strengthening process relative to Comparative Example AA (0.23 wt %<0.26 wt %). Also, even with the increased initial LiNO₃ concentration in Example 1-A, the 0.2 wt % TSP in Example 1-A is able to decrease the LiNO₃ concentration at the end of the chemical strengthening process to roughly the same level as Example 4-A (where half the amount of TSP was used). As shown in Table 3, the pH of the molten salt solution follows the same trend as the LiNO₃ concentration.

Table 3 also presents the concentration of LiNO₃ 4 hours after the end of the chemical strengthening treatment—with no action taken to the molten salt solution other than maintaining the temperature after the end of the chemical strengthening treatment (and the addition of TSP in Comparative Example AA-A). If no TSP was added for Comparative Example AA-A, it is to be understood that the LiNO₃ concentration 4 hours after the end of the chemical strengthening treatment would be the same as the LiNO₃ concentration at the end of the chemical strengthening treatment. Adding the TSP at the end of the chemical strengthening treatment (after the glass-based article is removed from the molten salt solution), decreases the LiNO₃ concentration to about 0.18 wt % 4 hours after the end of chemical strengthening treatment; however, 0.18 wt % is still greater than the initial LiNO₃ concentration. For Example 4-A, the LiNO₃ concentration 4 hours after the end of the chemical strengthening treatment is about the same as Comparative Example AA-A (about 0.18 wt %); however, the amount of TSP added in Example 4-A is only half of that added at the end of the chemical strengthening treatment in Comparative Example AA-A. Consequently, it is unexpectedly seen that adding the phosphate salt (TSP) during the chemical strengthening treatment has a greater effect on decreasing LiNO₃ concentration 4 hours after the end of chemical strengthening treatment compared to the same measurement when the phosphate salt is added after the chemical strengthening treatment. As a more direct comparison, Example 1-A uses the same amount of phosphate salt as Comparative Example AA-A; here, the LiNO₃ concentration 4 hours after the end of the chemical strengthening treatment is about 0.02 wt % lower for Example 1-A (0.16 wt %) than Comparative Example AA-A (about 0.18 wt %). This further demonstrates the unexpected benefits associated with adding the phosphate salt during the chemical strengthening process.

Table 4 presents the conditions and properties of Examples 5-6 and Comparative Examples CC-DD. For Comparative Example DD, the glass sample comprised Composition C2 (instead of Composition C1) comprising in mol %: 65.2 SiO₂, 1.1 Al₂O₃, 26.3 Li₂O, 0.1 Na₂O, 0.1 K₂O, 1.6 CaO, 3.9 ZrO₂, 1.6 P₂O₅, and 0.1 SnO₂. Examples 5-6 and Comparative Examples CC-DD were chemically strengthened in a larger molten salt bath—corresponding to an industrial scale molten salt solution—to produce sufficient samples for testing, as reporting in FIGS. 11-14. As shown in Table 4, the initial LiNO₃ concentration for Comparative Examples CC-DD was lower than that for Examples 5-6 (0.12 wt %<0.18 wt %), which puts Comparative Examples CC-DD at an advantage, although Examples 5-6 had non-zero initial TSP to compensate for this difference.

TABLE 4
Conditions and Properties of Examples
5-6 and Comparative Examples CC-DD

| | | | TSP | |
|---|---|---|---|---|
| | Initial LiNO₃ | Initial TSP | after Start | TSP Added |
| Example | (wt %) | (wt %) | (min) | (wt %) |
| CC | 0.12 | n/a (0) | n/a | n/a (0) |
| DD | 0.12 | n/a (0) | n/a | n/a (0) |
| 5 | 0.18 | 0.24 | 60 | 0.154 |
| 6 | 0.18 | 0.24 | 95 | 0.077 |

For example, FIGS. 11-12 illustrate a relationship between failure stress (of) in MegaPascals (MPa) on the vertical axis 1103 (i.e., y-axis) or failure load (Lf) on the vertical axis 1203 (i.e., y-axis) as a function of flaw depth (df) in micrometers (μm) on the horizontal axis 1101 or 1201 (i.e., x-axis) using the Ring-on-Ring Test. As shown in FIG. 11, curve 1105 shows the trend for points 1107 of Comparative Example CC without the addition of the phosphate salt during the chemical strengthening process without while curve 1115 shows the trend for points 1117 for Examples 5-6 (combined), where phosphate salt was added during the chemical strengthening process. For extremely small flaw depths (e.g., df<10 μm), the curves 1105 and 1115 (and/or points 1107 and 1117) substantially overlap. However, at flaw depths from about 10 μm to about 60 μm, curve 1115 is above curve 1105. For example, at a flaw depth of 40 μm, curve 1115 is about 750 MPa while curve 1105 is less than 400 MPa. Likewise, at a flaw depth of 20 μm, curve 1105 is about 1000 MPa while curve 1105 is less than 750 MPa. Further, a ratio of the failure strength at 40 μm to the failure strength at 20 μm (as a percentage) for curve 1115 is about 75%. In contrast, the corresponding ratio of curve 1105 is less than 60%. Consequently, the methods of present disclosure enable increased retained strength for flaw depths (e.g., from 20 μm to 60 μm). In aspects, methods of the present disclosure adding a phosphate salt to the molten salt bath during the chemical strengthening can produce a glass-based article that exhibits a retained strength that is greater than or equal to a corresponding retained strength of a comparative article chemically strengthened without the addition of a phosphate salt during the chemical strengthening process but otherwise the same—the same bulk composition, the same initial composition of the molten salt solution, and the same temperature and time for the chemical strengthening treatment.

In FIG. 12, curve 1205 shows the trend for points 1207 of Comparative Example CC; curve 1215 shows the trend for points 1217 for Example 5; and curve 1225 shows the trend for points 1227 for Example 6. As shown, the failure load for Examples 5-6 were greater than those for Comparative Example CC for corresponding flaw depths.

FIGS. 13-14 illustrate flaw depth (df) in micrometers (μm) on the vertical axis 1303 or 1403 (i.e., y-axis) for Examples 5-6 and Comparative Example CC-DD as measured in the Slapper Test using an 80 grit slapper (FIG. 13) or a 30 grit slapper (FIG. 14). As discussed below, Comparative Examples CC-DD were chemically strengthened without the addition of a phosphate salt while Examples 5-6 had a phosphate salt added to the molten salt solution during the chemical strengthening process.

In FIG. 13, Comparative Example CC had a flaw depth 1305 of 63.5 μm, Example 5 had a flaw depth 1307 of 59.8 μm, and Example 6 had a flaw depth 1309 of 63.8 μm. As shown in FIG. 13, the effective flaw depth was about 60 μm with the error bars overlapping for Examples 5-6 and Comparative Example CC.

In FIG. 14, Comparative Example CC had a flaw depth 1405 of 188.3 μm, Comparative Example DD had a flaw depth 1407 of 132.3 μm, Example 5 had a flaw depth 1409 of 100.5 μm, and Example 6 had a flaw depth 1411 of 92.5 μm. As shown in FIG. 14, Comparative Example CC had the worst performance with an effective flaw depth of 188 μm, followed by Comparative Example DD that had an effective flaw depth of 132 μm; Examples 5-6 had effective flaw depths of 101 μm and 93 μm, respectively. In particular, the effective flaw depth for Example 5-6 is much lower than the effective flaw depth for Comparative Example CC, which demonstrates that Examples 5-6 are better able to prevent the larger flaw depths seen in Comparative Example CC from forming. This result is even more remarkable considering the advantage given to Comparative Example CC (and DD) in having a lower initial LiNO₃ concentration than Examples 5-6.

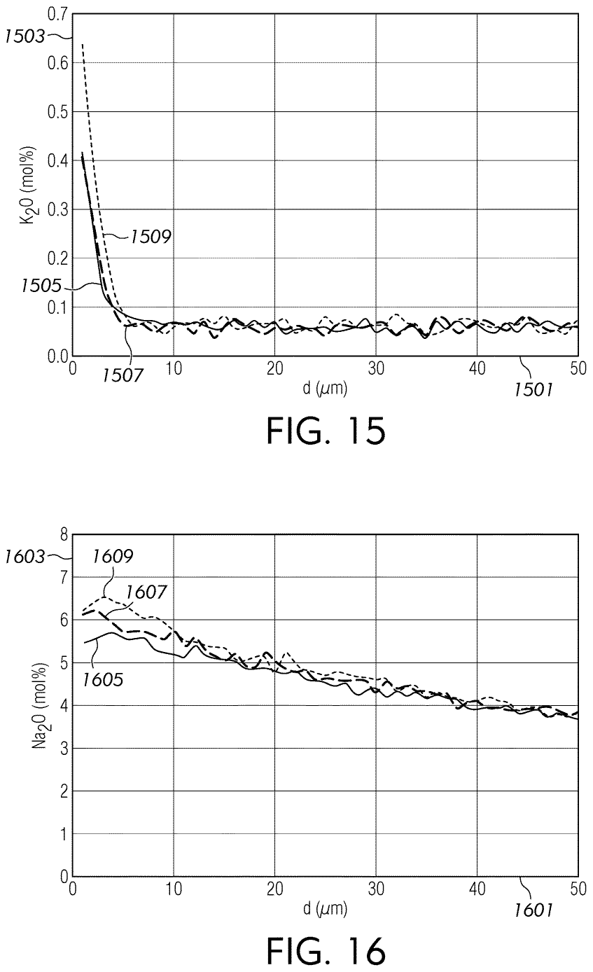

FIGS. 15-16 presents concentration profiles measured for Examples 5-6 and Comparative Example CC measured using electron microprobe analysis (EMPA). FIG. 15 illustrates potassium oxide (K₂O) concentration profiles in mol % on the vertical axis 1503 (i.e., y-axis) as a function of depth (d) from the surface is micrometers (μm) on the horizontal axis 1501 (i.e. x-axis). In FIG. 15, curve 1505 corresponds to Comparative Example CC, curve 1507 corresponds to Example 6, and curve 1509 corresponds to Example 5. As shown, the near-surface spike (in K₂O) is essentially the same for curves 1505 and 1507 (i.e., Comparative Example CC and Example 6, respectively)—even though Comparative Example CC had lower initial concentration of LiNO₃ than Example 6. Without the added phosphate salt (TSP) in Example 6, it would be expected that the near surface spike in curve 1507 would be lower than curve 1505 because the initially higher LiNO₃ concentration in Example 6 would translate to higher final LiNO₃ (when there is no added phosphate salt) that competes with potassium (and sodium) in the molten salt solution to ion-exchange with the glass-based substrate—and therefore reduces the amount of potassium ion-exchanged into the glass-based (generally and particularly) near the end of the chemical strengthening treatment.

Also, the near-surface spike (in K₂O) is greater for curve 1509 (Example 5) than curves 1505 and 1507 (Comparative Example CC and Example 6). As discussed above, the increase in the near-surface spike for curve 1509 (Example 5) is believed to be due to the phosphate salt removing more of the lithium (e.g., lithium nitrate) in the molten salt solution that was released from the glass-based substrate into the molten salt solution than Example 6 (curve 1507). Here, both the higher amount of TSP added and earlier addition of TSP in Example 5 (compared to Example 6) are believed to contribute to this result. The earlier addition of the phosphate salt in Example 5 (compared to Example 6) allows more time for the phosphate salt to take effect, which removes more lithium from the molten salt solution. As discussed above, the decreased lithium concentration in the molten salt solution allows a higher concentration of potassium (and/or sodium) to ion-exchange into the glass-based substrate (generally and particularly) near the end of the chemical strengthening treatment when the lithium concentration would otherwise be expected to be at its highest. Consequently, the higher near-surface potassium concentration in curve 1509 (due to decreased lithium concentration in the molten salt solution, especially near the end of the chemical strengthening treatment) enables higher compressive stress (e.g., surface compressive stress) to be generated. Notably, the maximum near-surface concentration of potassium for curve 1509 is about at least 50% greater than the corresponding value for curves 1505 and 1507.

FIG. 16 illustrates sodium oxide (Na₂O) concentration profiles in mol % on the vertical axis 1603 (i.e., y-axis) as a function of depth (d) from the surface is micrometers (μm) on the horizontal axis 1601 (i.e. x-axis). In FIG. 16, curve 1605 corresponds to Comparative Example CC, curve 1607 corresponds to Example 6, and curve 1609 corresponds to Example 5. Compared to FIG. 15, the relative effect on sodium concentration is less pronounced in FIG. 16. However, differences can still be seen in the near-surface behavior. Curve 1605 (Comparative Example CC) has the lowest near-surface sodium concentration, followed by curve 1607 (Example 6), and curve 1609 (Example 5) with the highest sodium concentration. As with potassium (discussed above), sodium competes with lithium for ion-exchange such that higher lithium concentration in the molten salt solution decreases the amount of sodium ion-exchanged into the glass-based substrate (relative to lower lithium concentrations in the molten salt solution). Consequently, the higher near surface concentration of sodium for curves 1607 and 1609 demonstrate that the reduction in lithium concentration in the molten salt solution from the phosphate salt (in Examples 5-6 relative to Comparative Example CC) leads to an increase in the near-surface concentration (in the glass-based article) of the other components in the molten salt solution (e.g., sodium and potassium).

The above observations can be combined to provide methods of chemically strengthening glass by adding a phosphate salt to the molten salt solution during the chemical strengthening process and glass-based articles produced using the same. Adding a phosphate salt (e.g., less than or equal to 2.0 wt %, from 0.05 wt % to 0.5 wt %) to the molten salt solution during the chemical strengthening process can increase the properties of the resulting glass-based article without leaving residues, without impairing the optical properties, and/or without impairing the cosmetic appearance of the resulting glass-based article. Also, adding the phosphate salt can enable elevated compressive stress, including at depths greater than those typically achieved from a potassium spike in a multi-step ion-exchange process, to be achieved. In particular, the high lithium glasses discussed herein can release a significant amount of lithium into the molten salt solution that could otherwise impair the compressive stress achieved-especially near the surface of the glass-based substrate.

Without wishing to be bound by theory, it is believed that the phosphate salt can preferentially bind to lithium cations in the molten salt solution (e.g., that can be present due to the current and/or previous chemical strengthening treatments using the molten salt solution), which can improve the stress profile and/or mechanical properties of the resulting glass-based article. For example, when the phosphate salt is trisodium phosphate (Na₃PO₄, TSP) can react with lithium in the molten salt solution to form lithium disodium phosphate (LiNa₂PO₄) that can precipitate out of the molten salt solution, reducing the concentration of lithium in solution in the molten salt solution. Consequently, removing (or at least decreasing an activity) of lithium in the molten salt solution can increase the effect of the chemical strengthening treatment on the resulting stress profile and/or mechanical properties since the competition between lithium and larger alkali metals is reduced. As demonstrated by the Examples herein (see Table 1 and FIG. 10), adding the phosphate salt can increase a maximum compressive stress (e.g., at the first major surface) and/or compressive stress at a predetermined depth (e.g., 20 μm, 40 μm) from the first major surface. Also, as demonstrated by the Examples herein (see FIG. 11), the addition of the phosphate salt can increase a retained strength (i.e., failure strength) of the resulting glass-based article for flaws having an intermediate depth (e.g., from 20 μm to 60 μm). Additionally, as shown in FIG. 14, the addition of the phosphate salt can reduce an extent of flaws (i.e., effective flaw depth) formed in the Slapper Test.

Without wishing to be bound by theory, it is believed that the phosphate salt can take a significant amount of time (e.g., greater than or equal to an hour, from greater than or equal to 2 hours to less than or equal to 4 hours) to achieve the full extent of the lithium concentration reduction. Consequently, adding the phosphate salt partway (e.g., at least 45 minutes after the start of the chemical strengthening process with that molten salt solution, at least 45 minutes before the end of the chemical strengthening process with that molten salt solution, from 25% to 75% of the way through the chemical strengthening process with that molten salt solution), can act to reduce (e.g., limit, reduce) the lithium concentration in the molten salt solution throughout a significant portion of the remainder of the chemical strengthening process (if not the entire remainder of the chemical strengthening process). As a result, the composition of the molten salt bath can shift from before the phosphate salt is added versus after the phosphate salt is added. In some situations, this shift in composition (through the removal and/or decreased activity of lithium) can have an effect similar to a multi-step chemical strengthening process even though a single molten salt solution is used. Additionally or alternatively, the addition of the phosphate salt can limit a maximum concentration of lithium in the molten salt solution during the chemical strengthening process. Consequently, higher compressive stress and/or stress profiles can be achieved as the effect of reverse ion-exchange from the lithium concentration in the molten salt solution is reduced. In particular, when the composition of the glass-based substrate being chemically strengthened contains a larger amount of lithium (e.g., from greater than or equal to 20 mol % to less than or equal to 45 mol %), an increase in lithium concentration in the molten salt solution can be significant (e.g., greater than or equal to 0.1 wt %) during the chemical strengthening process. Adding the phosphate salt in this situation, can mitigate the extent of this increase in lithium. Additionally, adding the phosphate salt during the chemical strengthening treatment can increase a throughput and/or a longevity of the molten salt solution. As discussed above, the phosphate salt can take a significant amount of time to have full effect; so, adding the phosphate salt during the chemical strengthening process can reduce an amount of time after the end of the chemical strengthening process before the phosphate salt has full effect, which allows for a subsequent chemical strengthening processing using the molten salt solution to begin sooner than if the phosphate salt was added after the chemical strengthening process was complete.

The addition of the phosphate salt during the chemical strengthening of the glass-based substrate (to form the glass-based article) can reduce the extent that a lithium concentration increases during the remainder of the chemical strengthening process (e.g., after the phosphate salt is added). Additionally or alternatively, the addition of the phosphate salt during the chemical strengthening of the glass-based substrate (to form the glass-based article) can reduce the extent that a lithium concentration increases by the time that the phosphate salt takes full effect (e.g., 4 hours after the end of the chemical strengthening process). Additionally or alternatively, the addition of the phosphate salt can achieve a lithium concentration in the molten salt solution (based on 100 wt % of the molten salt solution)—at the end of the chemical strengthening process and/or 4 hours after the end of the chemical strengthening process with the corresponding molten salt solution—below a predetermined threshold (e.g., less than or equal to 0.30 wt %, from greater than or equal to 0.10 wt % to less than or equal to 0.30 wt %). Further, due to the high lithium content glass-based substrates being chemically strengthened, the phosphate released from the phosphate salt can bind with lithium already released into the molten salt solution rather than aggregating at the surface of glass-based substrate where it could cause cosmetic defects (e.g., “spotting”). Indeed, adding the phosphate salt partway through the chemical strengthening can ensure that there is sufficient lithium in the molten salt solution for this binding to occur.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

What is claimed is:

1. A method of chemically strengthening a glass-based substrate comprising:
contacting at least a first major surface of the glass-based substrate with a molten salt solution maintained at a first temperature from greater than or equal to 330 °C to less than or equal to 530 °C for a first period of time from greater than or equal to 10 minutes to less than or equal to 8 hours to form a compressive stress region extending from the first major surface to a depth of compression; and
adding a phosphate salt to the molten salt solution during the contacting.

2. The method of claim 1, wherein the phosphate salt comprises trisodium phosphate (Na₃PO₄), tripotassium phosphate (K₃PO₄), disodium phosphate (Na₂HPO₄), dipotassium phosphate (K₂HPO₄), sodium tripolyphosphate (Na₅P₃O₁₀), potassium tripolyphosphate (Na₅P₃O₁₀), sodium pyrophosphate (Na₄P₂O₇), potassium pyrophosphate (K₄P₂O₇), trisodium pyrophosphate (Na₃HP₂O₇), tripotassium pyrophosphate (K₃HP₂O₇), disodium pyrophosphate (Na₂H₂ P₂O₇), dipotassium pyrophosphate (K₂H₂P₂O₇), or combinations thereof.

3. The method of claim 1, wherein an amount of the phosphate salt added to the molten salt solution, based on 100 wt % of the molten salt solution before adding the phosphate salt, is from greater than or equal to 0.05 wt % to less than or equal to 2.0 wt %.

4. The method of claim 3, wherein the amount of the phosphate salt added to the molten salt solution is from greater than or equal to 0.10% wt % to less than or equal to 0.5 wt %.

5. The method of claim 1, wherein the phosphate salt is added at a time after a start of the contacting, where the time is from 25% to 75% of the first period of time.

6. The method of claim 1, wherein the first period of time is from greater than or equal to 2 hours to less than or equal to 6 hours, wherein the phosphate salt is added from 45 minutes to 105 minutes after a start of the contacting.

7. The method of claim 1, wherein the first period of time is from greater than or equal to 2 hours to less than or equal to 6 hours, wherein the phosphate salt is added from 45 minutes to 105 minutes prior to an end the contacting.

8. The method of claim 1, wherein the glass-based substrate is a lithium-containing aluminosilicate glass.

9. The method of claim 8, wherein the glass-based substrate comprises, based on 100 mol % of the glass-based substrate:
from greater than or equal to 50 mol % to less than or equal to 75 mol % SiO₂;
from greater than or equal to 0.5 mol % to less than or equal to 5 mol % Al₂O₃;
from greater than or equal to 20 mol % to less than or equal to 45 mol % Li₂O;
from greater than or equal to 0.0 mol % to less than or equal to 2.0 mol % Na₂O;
from greater than or equal to 0.0 mol % to less than or equal to 1.0 mol % K₂O;
from greater than or equal to 0.0 mol % to less than or equal to 5.0 mol % RO, where RO is a total amount of MgO, CaO, SrO, and BaO;
from greater than or equal to 0.0 mol % to less than or equal to 6.0 mol % ZrO₂; and
from greater than or equal to 0.1 mol % to less than or equal to 3.0 mol % P₂O₅.

10. The method of claim 9, wherein the glass-based substrate comprises, based on 100 mol % of the glass-based substrate:
from greater than or equal to 20 mol % to less than or equal to 45 mol % Li₂O;
from greater than or equal to 0.0 mol % to less than or equal to 2.0 mol % RO, where RO is a total amount of MgO, CaO, Sr, and BaO;
from greater than or equal to 1.0 mol % to less than or equal to 4.0 mol % ZrO₂; and
from greater than or equal to 0.2 mol % to less than or equal to 2.0 mol % P₂O₅.

11. The method of claim 8, wherein a concentration of lithium in solution in the molten salt solution after an end of the contacting is, as a percentage of the concentration of lithium in solution in the molten salt solution before the contacting, from greater than or equal to 50% to less than or equal to 133%.

12. The method of claim 8, wherein a concentration of lithium in solution in the molten salt solution decreases from an end of the contacting to 4 hours after the end of the contacting.

13. The method of claim 8, wherein a concentration of lithium in solution in the molten salt solution decreased from before the contacting to 4 hours after an end of the contacting.

14. The method of claim 8, wherein a concentration of lithium in solution in the molten salt solution 4 hours after an end of the contacting, based on 100 wt % of the molten salt solution 4 hours after the end of the contacting, is from greater than or equal to 0.10 wt % to less than or equal to 0.30 wt %.

15. The method of claim 1, wherein the molten salt solution comprises, based on 100 wt % of the molten salt solution before the contacting:
from greater than or equal to 20 wt % to less than or equal to 100 wt % of a sodium salt; and
from greater than or equal to 0 wt % to less than or equal to 80 wt % of a potassium salt.

16. The method of claim 1, wherein the depth of compression is greater than or equal to 100 micrometers.

17. The method of claim 1, wherein a maximum compressive stress in the compressive stress region is greater than or equal to 350 MegaPascals, and a stress at a depth of 40 micrometers from the first major surface is greater than or equal to 200 MegaPascals after the contacting.

18. The method of claim 1, wherein:
after the contacting, the glass-based substrate exhibits a retained strength at a flaw depth of 40 micrometers is greater than or equal to 500 MegaPascals;
after the contacting, the glass-based substrate exhibits a flaw depth from greater than or equal to 50 micrometers to less than or equal to 140 micrometers in a Slapper Test; or both.

19. A glass-based article produced by the method of claim 1.

20. A consumer electronic device comprising:
a housing comprising a front surface, a back surface, and side surfaces;
electrical components at least partially within the housing, the electrical components comprising a controller, a memory, and a display, the display is at or adjacent to the front surface of the housing; and
a cover substrate disposed over the display,
wherein at least one of a portion of the housing or the cover substrate comprises a glass-based article produced by the method of claim 1.
